(19) United States
(12) Patent Application Publication
(10) Pub. No.: US 2022/0347793 A1
(43) Pub. Date: Nov. 3, 2022

(54) HOUSING FOR A HEAD FOR DIRECTING AN ELECTROMAGNETIC RADIATION BEAM AT A TARGET AND A METHOD OF MANUFACTURING A HEAD FOR DIRECTING AN ELECTROMAGNETIC RADIATION BEAM AT A TARGET

(71) Applicant: ALLTEC ANGEWANDTE LASERLICHT TECHNOLOGIE GMBH, Selmsdorf (DE)

(72) Inventors: Peter J. Kueckendahl, Bad Oldesloe (DE); Christian Seuthe, Selmsdorf (DE); Andreas Luechow, Schoenwalde (DE); Christian Wulf, Klein Wesenberg (DE); Till Franitza, Lubeck (DE)

(21) Appl. No.: 17/761,827

(22) PCT Filed: Sep. 18, 2020
(86) PCT No.: PCT/EP2020/076132

§ 371 Date: Mar. 18, 2022

(30) Foreign Application Priority Data
Sep. 20, 2019 (GB) 1913628.2

(51) Int. Cl. B23K 26/14; B23K 26/064; B23K 26/082; B23K 26/352

(52) U.S. Cl. CPC B23K 26/14; B23K 26/064; B23K 26/082; B23K 26/352

(57) ABSTRACT

There is provided a housing for a head for directing an electromagnetic radiation beam at a target, the housing comprising: an inlet for receiving a fluid; a cavity for enclosing at least one component for controlling the optical path of the radiation beam within the marking head; an outlet for the fluid; a first channel defining a first fluid path from the inlet to the cavity; and a second channel defining a second fluid path from the cavity to the outlet. When the at least one component for controlling the optical path of the radiation beam is enclosed within the cavity, the housing and the at least one component further define a third channel between the first channel and the second channel. The first channel, second channel and third channel are configured to isolate the fluid from the optical path of the radiation beam within the head. There is also provided a method of manufacturing a head for directing an electromagnetic radiation beam at a target.

### TECHNICAL FIELD

The present invention relates to a housing for a head for directing an electromagnetic radiation beam at a target and to a method of manufacturing a head for directing an electromagnetic radiation beam at a target.

### BACKGROUND

Radiation marking systems, for instance laser marking systems may be utilized in production lines for various types of articles or products—for example, they may be used to imprint bar codes, unique identifying marks, expiration dates, or other information on items passing through a production line.

Laser marking systems comprise a laser source for providing a laser beam and a marking head for directing the laser beam at a product. The marking head houses multiple components required to safely and effectively direct the laser beam at a product.

Given the number and size of the multiple components required to safely and effectively direct and project the laser beam on to a product, the marking head is typically large and bulky. It would be desirable to provide for a smaller marking head. However, a smaller head puts additional constraints on the marking head and system. The components within the marking head generate lots of heat and a smaller marking head means that there is less space for the heat to dissipate. This can pose problems with overheating of the components and/or marking head, and/or potential damage thereto.

In addition, when the laser beam is projected on to a product, the interaction of the radiation with the product may result in the production of matter e.g. gaseous matter such as fumes and/or solid matter such as particulate debris. If this matter is not dissipated effectively, the fumes may be unpleasant and/or harmful to users, and any solid matter may deflect back up on to the marking head potentially causing damage to the marking head.

It would be desirable to provide an effective cooling system for a head for directing an electromagnetic radiation beam at a target. It would be desirable to provide a housing, in particular a compact housing, for a head for directing an electromagnetic radiation beam at a target that alleviates or overcomes one or more of the above mentioned problems.

### SUMMARY

According to a first aspect of the present invention, there is provided a housing for a head for directing an electromagnetic radiation beam at a product, the housing comprising:

an inlet for receiving a fluid;

a cavity for enclosing at least one component for controlling the optical path of the radiation beam within the head;

an outlet for the fluid;

a first channel defining a first fluid path from the inlet to the cavity; and

a second channel defining a second fluid path from the cavity to the outlet;

wherein when the at least one component for controlling the optical path of the radiation beam is enclosed within the cavity, the housing and the at least one component further define a third channel between the first channel and the second channel; and

wherein the first channel, second channel and third channel are configured to isolate the fluid from the optical path of the radiation beam within the head.

The third channel therefore defines a fluid path through the cavity and around an outer surface of the component. When cooling fluid such as compressed air is received by the housing and flows through the third channel, the cooling fluid passes over the component to cool it.

A housing for a marking head with this particular configuration provides for a more compact marking head, which is highly advantageous.

The housing has been provided with a cavity designed to enclose a component of the marking head responsible for generating most of the heat residing in the marking head, particularly an actuator for controlling the position of the mirrors that direct the radiation beam through the marking head. By directing the cooling fluid to this particular component, the cooling provided will have a greater effect on reducing the overall temperature of the marking head.

In addition, the cavity and the first and second channels have been arranged in this way so that the third channel is created by the provision of just the housing and the component itself. Since the third channel is created by the provision of the component itself, the third channel must enclose an outer surface of the component, where it is intended to provide the cooling. This reduces the number of parts required for cooling the component.

The housing enables this cooling to take place whilst isolating the cooling fluid from the optical path of the radiation beam to prevent any interference with the radiation beam, and so to therefore prevent any complications that may arise due to any such interference.

The housing therefore provides an efficient path for cooling fluid, particularly compressed air, to pass from the inlet, over the component to be cooled, and towards the outlet to dissipate the heat within the marking head.

As such, the housing therefore provides for an improved cooling system for a marking head for a radiation marking system, which allows components of the marking head to be placed closer together within the marking head without overheating. Since components of the marking head can be placed closer together, the housing and therefore marking head can be made more compact.

The cavity may be configured to enclose the at least one component for controlling the optical path of the radiation beam within the head.

The housing may be configured to cooperate with a support member for supporting the at least one component within the cavity, wherein the housing is configured to cooperate with the support member and the at least one component for enclosing the at least one component within the cavity.

The at least one component may need to be somehow supported within the head. Therefore, by using a support member (that may be required in any case) to define the channel for cooling the at least one component, the number of parts required may be reduced, allowing for the provision of a more compact head.

The support member may comprise a recessed portion for cooperating with the cavity and the at least one component when the support member is supporting the at least one component within the cavity, wherein the housing, the at least one component and the support member define at least a part of the third channel, and/or wherein the cavity and the recessed portion provide the third channel. The housing, the at least one component and the support member may define the third channel.

This may provide an effective way of defining a channel for cooling the at least one component. Since the support member may extend around the entire outer surface of the at least one component it may provide for a longer fluid path and therefore enhanced cooling.

The housing may comprise a second cavity for enclosing at least one second component for controlling the optical path of the laser beam within the marking head, and wherein the housing defines a fourth channel defining a fluid path from the third channel to the second channel, and wherein the fourth channel is fluidly connected to the second cavity, wherein the first channel, second channel, third channel and fourth channel are configured to isolate the fluid from the optical path of the radiation beam within the head.

This may provide a particularly effective cooling system for a head. The actuators for controlling the optical path of the laser beam through the head may operate at very high frequencies, generating significant amounts of heat. By providing a housing able to direct fluid to both actuators, a greater cooling effect may be achieved. This may be particularly effective when the head has a parallel actuator configuration as the head may be made more compact, the actuators may be placed closer together and so enhanced cooling may be required.

The second cavity may be configured to enclose the at least one second component for controlling the optical path of the radiation beam within the head.

When the at least one second component for controlling the optical path of the radiation beam is enclosed within the second cavity, the housing and the at least one second component define a fifth channel between the fourth channel and the second channel wherein the first channel, second channel, third channel, fourth channel and fifth channel are configured to isolate the fluid from the optical path of the radiation beam within the head.

Since the fifth channel may be created by the provision of the component itself, the fifth channel must enclose an outer surface of the component, where it is intended to provide the cooling. This may reduce the number of parts required for cooling the component. The fifth channel may therefore define a fluid path through the second cavity and around the outer surface of the second component. When cooling fluid such as compressed air is received by the housing and flows through the fifth channel, the cooling fluid passes over the second component to cool it.

The first cavity may define a first longitudinal axis and the second cavity may define a second longitudinal axis, and wherein the first longitudinal axis may be substantially parallel to the second longitudinal axis and/or to a longitudinal axis of the head.

This may provide for a parallel actuator configuration as mentioned above, where the actuators may be placed closer together and so enhanced cooling may be required.

The third channel may extend around an entire circumference of the at least one first component. The fifth channel may extend around an entire circumference of the at least one second component.

The outlet may be fluidly connected to a guide portion and the guide portion may be arranged to receive fluid from the outlet and to direct the fluid at a predetermined angle relative to and across an optical element through which radiation is emitted from the head. The guide portion may be arranged to receive fluid from the outlet and to direct the fluid at a predetermined angle relative to a plane comprising an optical element of the head through which radiation is emitted from the head, and towards the emitted radiation. Towards may be used to mean “in the direction of”.

The guide portion may therefore be used to provide an effective air knife, for example across the optical element through which radiation is emitted from the head. Across may mean towards the emitted radiation. This may prevent particulate matter deflecting back up and onto the optical element for example, and/or may help dissipate harmful and/or unpleasant fumes produced by projecting the beam onto a product. The cooling system may therefore have a dual purpose in that the fluid can be used for cooling, as well as for the generation of an effective air knife at the outlet.

The predetermined angle may be relative to a plane comprising the outlet.

The outlet may comprise a valve. This may help prevent particulate matter entering the housing through the outlet.

The guide portion may comprise at least one surface arranged at the predetermined angle. The at least one surface may be arranged to receive fluid from the outlet and to direct the fluid at the predetermined angle relative to and across an optical element through which radiation is emitted from the head. Across may mean towards the emitted radiation.

The inventors have found that this may be a simple but effective way of generating an air knife at the outlet. Turbulence surrounding the air knife may be minimized when the air knife is generated in this way.

The head may define a longitudinal axis, and the head may be configured to direct a radiation beam out of the head in a direction substantially parallel to the longitudinal axis, and the predetermined angle may be substantially 45 degrees relative to a plane comprising an optical element through which radiation is emitted from the head.

The inventors have found that this angle may generate a very effective air knife for a head with a straight configuration. The turbulence surrounding the air knife may be minimized when the air knife is generated in this way. This reduces the chance of a turbulent airflow being generated that might direct particulate matter onto the optical element.

The predetermined angle may be between 40 and 50 degrees relative to a plane comprising the optical element through which radiation is emitted from the head.

The head may defines a longitudinal axis, and wherein the head is configured to direct a radiation beam out of the head in a direction substantially transverse to the longitudinal axis, and wherein the predetermined angle is substantially 60 degrees relative to a plane comprising an optical element through which radiation is emitted from the head. This may correspond to an angle of 30 degrees relative to the optical axis of the head where the radiation beam is emitted from the head.

The inventors have found that this angle may generate a very effective air knife for a head with a right-angled or 90 degree configuration. The turbulence surrounding the air knife may be minimized when the air knife is generated in this way.

The predetermined angle may be between 55 and 65 degrees relative to a plane comprising the optical element through which radiation is emitted from the head.

The predetermined angle relative to a plane comprising the optical element may be greater for a head with a straight configuration.

The at least one component for controlling the optical path of the radiation beam within the head may be for steering the radiation beam within and/or through the head. The at least one component for controlling the optical path of the radiation beam within the head may be a first actuator The at least one component for controlling the optical path of the radiation beam within the head may be a first actuator configured to rotate a first optical element of a radiation steering mechanism about a first rotational axis. The first actuator may comprise a galvanometer motor.

The at least one second component for controlling the optical path of the radiation beam within the head may be for steering the radiation beam within and/or through the head. The at least one second component for controlling the optical path of the radiation beam within the marking head may be a second actuator. The at least one second component for controlling the optical path of the radiation beam within the marking head may be a second actuator configured to rotate a second optical element about a second rotational axis. The first actuator may comprise a galvanometer motor.

The electromagnetic radiation may be laser. The head may be a marking head. The head may be a drilling system for drilling products, or a welding system for welding products.

The housing and/or the head may be configured to receive the electromagnetic radiation beam from an external source, external to the housing and/or the head. The housing and/or the head may be configured to receive the electromagnetic radiation beam from an external radiation source, external to the housing and/or the head. The radiation source for providing an electromagnetic radiation beam to the head and/or to the housing may be external to the head and/or to the housing.

The fluid may comprise air. The fluid may be air. The fluid may comprise compressed air. The fluid may be compressed air.

The target may be a product, and the product may be on a production line.

According to a second aspect of the present invention, there is provided a head for directing an electromagnetic radiation beam at a target, the head comprising:
(a) a housing for the head, the housing comprising:
   an inlet for receiving a fluid;
   a cavity for enclosing at least one component for controlling the optical path of the radiation beam within the head;
   an outlet for the fluid;
   a first channel defining a first fluid path from the inlet to the cavity; and
   a second channel defining a second fluid path from the cavity to the outlet; and
(b) the at least one component for controlling the optical path of the radiation beam within the marking head, wherein when the at least one component for controlling the optical path of the radiation beam is enclosed within the cavity, the housing and the at least one component further define a third channel between the first channel and the second channel; and
   wherein the first channel, second channel and third channel are configured to isolate the fluid from the optical path of the radiation beam within the head.

The head may comprise a support member for supporting the at least one component within the cavity, wherein the support member is configured to cooperate with the housing and the at least one component for enclosing the at least one component within the cavity.

The support member may comprise a recessed portion for cooperating with the cavity and the at least one component when the support member is supporting the at least one component within the cavity, and wherein the housing, the at least one component and the support member may define at least a part of the third channel and/or wherein the cavity and the recessed portion provide at least a part of the third channel.

The housing may comprise a second cavity for enclosing at least one second component for controlling the optical path of the laser beam within the marking head, and the housing may define a fourth channel defining a fluid path from the third channel to the second channel, and the fourth channel may be arranged to carry fluid to the second cavity. The first channel, second channel, third channel and fourth channel may be configured to isolate the fluid from the optical path of the radiation beam within the head.

The head may further comprise the at least one second component for controlling the optical path of the radiation beam within the head.

When the at least one second component for controlling the optical path of the radiation beam is enclosed within the second cavity, the housing and the at least one second component may define a fifth channel between the fourth channel and second channel.

The first cavity may define a first longitudinal axis and the second cavity may define a second longitudinal axis, and wherein the first longitudinal axis may be substantially parallel to the second longitudinal axis and/or to a longitudinal axis of the head.

The head may comprise an optical element assembly for emitting the radiation beam from the head, wherein the optical element assembly may comprise a first optical element arranged to receive the radiation beam to be emitted from the head, and a second optical element arranged to cover the first optical element and to receive the radiation beam emitted from the first optical element for emitting the radiation beam from the head.

The first optical element may be integrally formed with the head. The second optical element may be detachably connected to the head. The second optical element may be mounted to the head, for example by using screws. The plane of the first optical element may be parallel to the plane of the second optical element.

Provision of the second optical element in this way may protect the first optical element which maintains integrity of the internal components of the head. Providing an additional optical element that overlays the first optical element may prevent any particulate matter from contacting the first optical element. The second optical element being detachable may also make it easy to replace, for example if particulate matter scratches or attaches to the surface of the second optical element.

The head may comprise an optical element through which radiation is emitted from the head. The head may comprise a guide portion arranged to receive fluid from the outlet and to direct the fluid at a predetermined angle relative to and across an optical element of the head through which radiation is emitted from the head. The head may comprise a guide portion arranged to receive fluid from the outlet and to direct the fluid at a predetermined angle relative to a plane comprising an optical element of the head through which radiation is emitted from the head, and towards the emitted radiation.

The guide portion may comprise at least one surface arranged at the predetermined angle. The at least one surface may be arranged to receive fluid from the outlet and to direct the fluid at the predetermined angle relative to and across the optical element. Across may mean towards the emitted radiation. The at least one surface may define a cylindrical duct or conduit arranged the predetermined angle.

The head may define a longitudinal axis, and the head may be configured to direct a radiation beam out of the head in a direction substantially parallel to the longitudinal axis, and wherein the predetermined angle may be substantially 45 degrees relative to a plane comprising the optical element.

The head may comprise a cover for the outlet, and the cover may comprise the guide portion. The guide portion may comprise an angled or diagonal bore or through hole through the cover. The guide portion may be a diagonal bore or through hole defined in the cover.

The cover may be an effective way of preventing the ingress of particulate matter and/or gaseous matter into the outlet, whilst also providing for an effective air knife as discussed herein. The cover may be hooded.

The head may define a longitudinal axis, and wherein the head may be configured to direct a radiation beam out of the head in a direction substantially transverse to the longitudinal axis, and wherein the predetermined angle may be substantially 60 degrees relative to a plane comprising an optical element through which radiation is emitted from the head.

The at least one component for controlling the optical path of the radiation beam within the head may be a first actuator configured to rotate a first optical element of a radiation steering mechanism about a first rotational axis. The first actuator may comprise a galvanometer motor.

The at least one second component for controlling the optical path of the radiation beam within the head may be a second actuator configured to rotate a second optical element about a second rotational axis, The second actuator may comprise a galvanometer motor.

The electromagnetic radiation may be laser. The head may be a marking head. The housing and/or the head may be configured to receive the electromagnetic radiation beam from an external source, external to the housing and/or the head. The housing and/or the head may be configured to receive the electromagnetic radiation beam from an external radiation source, external to the housing and/or the head. The radiation source for providing an electromagnetic radiation beam to the head and/or to the housing may be external to the head and/or to the housing.

According to a third aspect of the present invention there is provided an electromagnetic radiation system for directing an electromagnetic radiation beam at a target comprising:

(a) a cabinet comprising a radiation source for providing an electromagnetic radiation beam, and a fluid source for providing cooling fluid; and

(b) a head connected to the cabinet, the head for directing the radiation beam at a target and for receiving the cooling fluid for cooling at least one component for controlling the optical path of the radiation beam within the head, the head comprising:
(i) a housing for the head, the housing comprising:
   an inlet for receiving a fluid;
   a cavity for enclosing the at least one component for controlling the optical path of the radiation beam within the head;
   an outlet for the fluid;
   a first channel defining a first fluid path from the inlet to the cavity; and
   a second channel defining a second fluid path from the cavity to the outlet; and
(ii) the at least one component for controlling the optical path of the radiation beam within the head, wherein when the at least one component for controlling the optical path of the radiation beam is enclosed within the cavity, the housing and the at least one component further define a third channel between the first channel and the second channel; and
wherein the first channel, second channel and third channel are configured to isolate the fluid from the optical path of the radiation beam within the head.
According to a fourth aspect of the present invention, there is provided a method of manufacturing a head for directing an electromagnetic radiation beam at a target, the method comprising:
   (a) providing a housing for the head, the housing comprising:
      an inlet for receiving a fluid;
      a cavity for enclosing at least one component for controlling the optical path of the radiation beam within the head;
      an outlet for the fluid;
      a first channel defining a first fluid path from the inlet to the cavity; and
      a second channel defining a second fluid path from the cavity to the outlet; and
   (b) enclosing the at least one component for controlling the optical path of the radiation beam within the cavity such that the housing and the at least one component further define a third channel between the first channel and the second channel; wherein the first channel, second channel and third channel are configured to isolate the fluid from the optical path of the radiation beam within the head.

The method may comprise providing a support member for supporting the at least one component within the cavity, wherein the support member is configured to cooperate with the housing and the at least one component for enclosing the at least one component within the cavity, and wherein enclosing the at least one component within the cavity comprises arranging the support member to cooperate with the housing and the at least one component.

The method may comprise providing a support member for supporting the at least one component within the cavity, wherein the support member is configured to cooperate with the housing and the at least one component for enclosing the at least one component within the cavity, and wherein enclosing the at least one component within the cavity comprises arranging the support member to cooperate with the housing and the at least one component.

The support member may comprise a recessed portion for cooperating with the cavity and the at least one component when the support member is supporting the at least one component within the cavity,

and arranging the support member within the head may comprise cooperating the recessed portion with the cavity and the at least one component to provide at least a part of the third channel, and wherein the housing, the at least one component and the support member define at least a part of the third channel.

The housing may comprise a second cavity for enclosing at least one second component for controlling the optical path of the radiation beam within the head, and the method may comprise enclosing the at least one second component for controlling the optical path of the radiation beam within the second cavity such that the housing and the at least one second component define a fifth channel between the third channel and the second channel, wherein the first channel, second channel, third channel and fifth channel may be configured to isolate the fluid from the optical path of the radiation beam within the head.

The first cavity may define a first longitudinal axis and the second cavity may define a second longitudinal axis, and the first longitudinal axis may be substantially parallel to the second longitudinal axis and to a longitudinal axis of the head.

The method may comprise providing the head with an optical element assembly for emitting the radiation beam from the head, wherein the optical element assembly may comprise a first optical element arranged to receive the radiation beam to be emitted from the head, and a second optical element arranged to cover the first optical element and to receive the radiation beam emitted from the first optical element for emitting the radiation beam from the head.

The method may comprise providing the head with an optical element through which radiation is emitted from the head, and arranging a guide portion on the head to receive fluid from the outlet and to direct the fluid at a predetermined angle relative to and across the optical element. Across may mean towards the emitted radiation.

The method may comprise providing the head with an optical element through which radiation is emitted from the head, and arranging a guide portion on the head to receive fluid from the outlet and to direct the fluid at a predetermined angle relative to a plane comprising the optical element towards the emitted radiation.

The guide portion may comprise at least one surface for directing the fluid at the predetermined angle.

The head may define a longitudinal axis, and wherein the head is configured to direct a radiation beam out of the head in a direction substantially parallel to the longitudinal axis, and wherein the predetermined angle is substantially 45 degrees relative to a plane comprising the optical element.

The method may comprise arranging a cover over the outlet on the head, wherein the cover may comprise the guide portion.

The head may define a longitudinal axis, and the head may be configured to direct a radiation beam out of the head in a direction substantially transverse to the longitudinal axis, and wherein the predetermined angle may be substantially 60 degrees relative to a plane comprising the optical element of the head.

The at least one component for controlling the optical path of the radiation beam within the head may be a first actuator configured to rotate a first optical element of a radiation steering mechanism about a first rotational axis. The first actuator may comprise a galvanometer motor.

The at least one second component for controlling the optical path of the radiation beam within the head may be a second actuator configured to rotate a second optical element about a second rotational axis. The second actuator may comprise a galvanometer motor.

The head may be a marking head. The head may be a drilling system for drilling products, or a welding system for welding products.

According to a fifth aspect of the present invention, there is provided a method of manufacturing an electromagnetic radiation system for directing an electromagnetic radiation beam at a target, the method comprising:

(a) manufacturing a marking head for directing an electromagnetic radiation beam at a target, comprising:
(i) providing a housing for the head, comprising:
   an inlet for receiving a fluid;
   a cavity for enclosing at least one component for controlling the optical path of the radiation beam within the head;
   an outlet for the fluid;
   a first channel defining a first fluid path from the inlet to the cavity; and
   a second channel defining a second fluid path from the cavity to the outlet; and
(ii) enclosing the at least one component for controlling the optical path of the radiation beam within the cavity such that the housing and the at least one component further define a third channel between the first channel and the second channel; wherein the first channel, second channel and third channel are configured to isolate the fluid from the optical path of the radiation beam within the head; and

(b) connecting the head to a cabinet, the cabinet comprising a radiation source for providing the radiation beam, and a fluid source for providing cooling fluid to the head to cool the at least one component for controlling the optical path of the radiation beam within the head.

According to a first example, there is provided a head for directing an electromagnetic radiation beam at a target, comprising:
an inlet for fluid;
an outlet for emitting fluid from the head;
one or more channels fluidly connecting the inlet and the outlet; and
an optical element adjacent the outlet through which the radiation beam is emitted from the head;
wherein the outlet comprises a guide portion arranged to receive fluid from the one or more channels and to guide the fluid to flow across, and at a predetermined angle relative to, the optical element. Across may be used to mean towards the emitted radiation.

The fluid may be air. The fluid may be compressed air. This may generate an effective air knife as described herein, to prevent particulate matter deflecting back up and onto the optical element for example, and/or may help dissipate harmful and/or unpleasant fumes produced by projecting the beam onto a target.

According to a second example, there is provided a cap or cover comprising an outlet for emitting fluid from a head for directing an electromagnetic radiation beam at a target, wherein the outlet comprises a guide portion arranged to receive fluid from the head and to guide the fluid to flow across, and at a predetermined angle relative to, an optical element of the head through which the radiation beam is emitted from the head.

The head and cap of these examples and any features thereof may comprise any one or more features of the head and cap or features thereof as described herein in relation to other examples, aspects or embodiments. The head and cap or cover of these examples can be provided without the provision of the cooling system or cooling path through the head as described herein.

Feature(s) of one aspect or embodiment or example as described and/or shown herein may be provided in conjunction with any other aspects or embodiments or example, or features thereof, as described and/or shown herein, as appropriate and applicable.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labelled in every drawing. Embodiments of the present invention will now be described, by way of example only, with reference to the accompanying drawings, in which:

FIG. 1 schematically depicts a cross-sectional view of an exemplary laser marking system;

FIG. 2 schematically depicts a magnified cross-sectional view of a marking head of the laser marking system of FIG. 1;

FIG. 3 schematically depicts a cross-sectional view of a cabinet of the laser marking system of FIG. 1;

FIG. 4 schematically depicts a cross-sectional view of the umbilical assembly of the laser marking system of FIG. 1;

FIG. 5 schematically depicts a cross-sectional view of a marking head indicating an optical path through the marking head and the flow of fluid through the marking head;

FIG. 6 schematically depicts a part cut away perspective view of a marking head housing indicting a fluid inlet of the housing;

FIG. 7 schematically depicts a perspective view of a marking head connected to an umbilical;

FIG. 8 schematically depicts a part cut away cross sectional view of a marking head housing received in a marking head, indicting first and second cavities;

FIG. 9 schematically depicts a part cut away cross sectional view of a marking head housing indicating part of a fluid flow path through the housing;

FIG. 10a schematically depicts a part cut away cross sectional view of a marking head housing indicating a first support member;

FIG. 10b schematically depicts a part cut away cross sectional view of a marking head housing indicating a second support member;

FIG. 11 schematically depicts a part cut away cross sectional view of a marking head housing indicating first and second openings of a first cavity;

FIG. 12a schematically depicts a part cut away cross sectional view of a marking head housing indicating a third opening of a second cavity;

FIG. 12b schematically depicts a part cut away cross sectional view of a marking head housing indicating a fourth and fifth openings in a second support member;

FIG. 13 schematically depicts a part cut away perspective view of a marking head housing indicating a fluid inlet of the housing;

FIG. 14 schematically depicts a part cut away perspective view of an end of a marking head indicating a hooded cap and optical element through which radiation is emitted from the head;

FIG. 15 schematically depicts an outlet of a marking head housing indicating a hooded cap and optical element through which radiation is emitted from the head;

FIGS. 16a and 16b show the graphical results of airflow simulations indicating the air knife created by a marking head with a straight configuration where the air is forced to flow at a 45° angle;

FIG. 17 schematically depicts a marking head having a right-angled or 90° configuration;

FIG. 18 schematically depicts a cap or cover for an outlet of a marking head having a right-angled or 90° configuration, indicating a duct or channel through the cap or cover;

FIGS. 19a and 19b show the graphical results of airflow simulations indicating the air knife created by a marking head having a right-angled or 90° configuration where the air is forced to flow at a 60° angle;

FIG. 20 schematically illustrates how a duct or channel as indicated in FIG. 18 may be created in the cap or cover;

FIG. 21 schematically depicts a perspective view of a cap or cover for an outlet of a marking head having a right-angled or 90° configuration, indicating a bore of the cap or cover;

FIG. 22 schematically depicts various views of a cap or cover for an outlet of a marking head having a right-angled or 90° configuration including some non-dimensioned geometry;

FIG. 23 schematically depicts a perspective view of a cap or cover for an outlet of a marking head having a right-angled or 90° configuration, indicating a bore of the cap and intended air flow out of the bore.

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways.

Aspects and embodiments disclosed herein include a laser system such as a laser scanning or marking system, although aspects may also include other laser systems such as laser drilling systems, laser welding systems and the like. Laser systems may be utilized in production lines for various types of articles or products. Laser marking systems may be utilized to imprint bar codes, unique identifying marks, expiration dates, or other information on items passing through a production line. In some implementations fiber lasers may be used in laser marking systems. Fiber lasers can produce beams of light in a range of wavelengths depending on the active element used but typically range from around 1000 nm to 2100 nm. Lasers utilized in laser marking systems are typically operated at laser power levels in the tens of watts, although laser power levels of kilowatts are possible. The laser may be pulsed or operated as a continuous wave. Typically pulsed operation is used for lower power applications such as marking and coding, whereas continuous wave operation is used for higher power applications such as cutting and welding.

Laser systems are not, however limited to fiber lasers and lasers of other forms may be used, including bulk solid state lasers, gas lasers, diode lasers, dye lasers and the like.

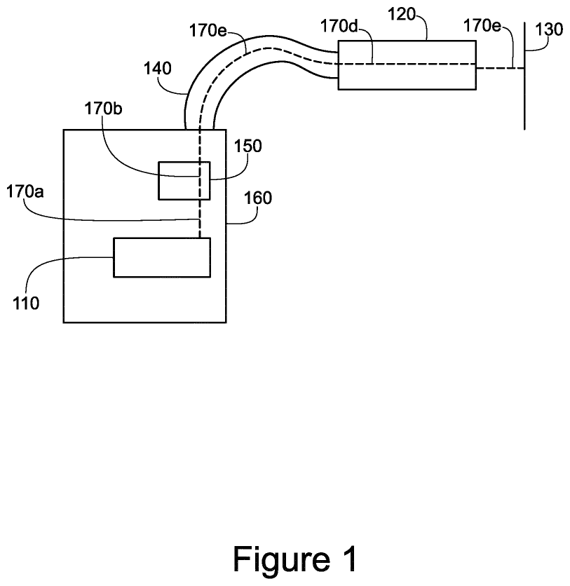

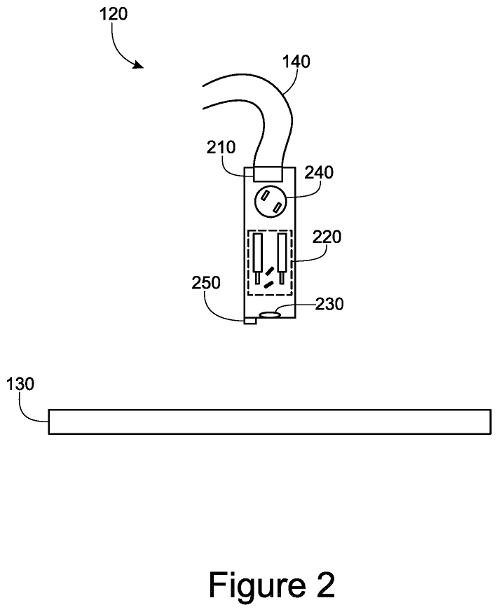

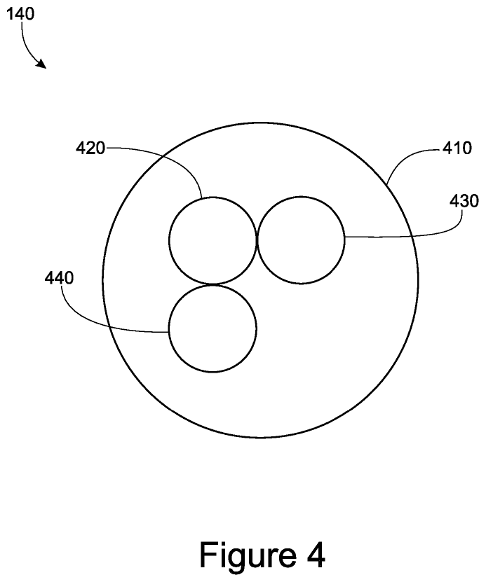

FIG. 1 schematically depicts a cross-sectional view of a laser marking system 100 according to an embodiment of the invention. The laser marking system 100 comprises a source of electromagnetic radiation such as a laser source 110 for providing a laser beam and a marking head 120 for projecting the laser beam towards a product 130. The laser source 110 and the marking head 120 are connected by an umbilical assembly 140 that transmits the laser beam from the laser source 110 to the marking head 120. The laser beam may be received by a collimator located within the marking head 120. The marking head 120 is described in further detail below with reference to FIG. 2 and the umbilical is described in further detail below with reference to FIG. 4.

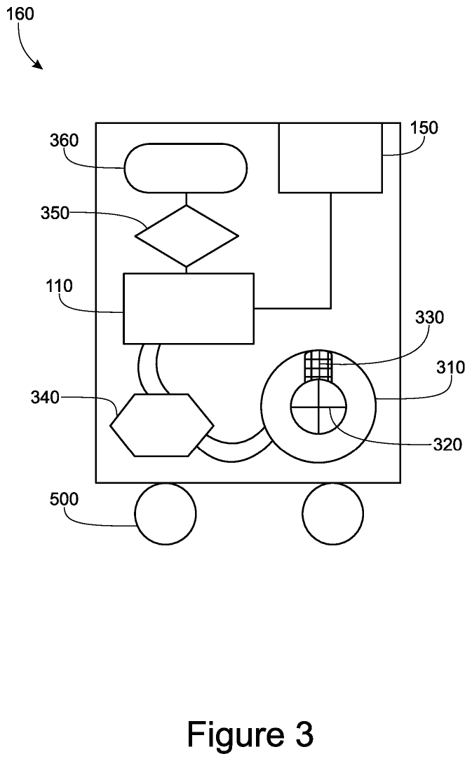

The laser marking system 100 further comprises an optical isolator 150 between the laser source 110 and the umbilical 140 such that the optical path of the laser beam provided by the laser source 110 passes through the optical isolator 150 before entering the umbilical 140. The laser source 110 and optical isolator may be housed within a cabinet 160. The cabinet and additional components that may be contained within the cabinet are described below with reference to FIG. 3.

The optical path of the laser beam from the laser source 110 to the product 130 is shown schematically in FIG. 1 by optical paths 170a to 170e. A first optical path 170a is defined between an output of the laser source 110 and the optical isolator 150. The first optical path may be provided by an optical fiber such as an optical fiber amplifier. A second optical path 170b is defined through the optical isolator 150. The second optical path 170b allows light to be transmitted from the laser source 110 to the umbilical 140 but prevents light being transmitted from the umbilical 140 to the laser source 110. The optical isolator therefore prevents light received into the umbilical through the marking head 120, for example reflected light emitted from the print head, entering the laser source 110 and prevents damage to the laser source 110.

A third optical path 170c is defined through the umbilical 140. The third optical path may be provided by a further optical fiber such as a transport fiber (sometimes referred to as a passive optical fiber). A fourth optical path 170d is defined through the marking head and a fifth optical path 170e is defined from the marking head to the product 130. The fourth optical path generally includes one or more components that allow the optical path to be modified as the laser beam passes through the marking head. Modification of the fourth optical path 170d within the marking head causes the fifth optical path 170e to also be modified such that the fifth optical path intersects the product in one of a plurality of marking positions. The laser beam emitted from the laser source 110 can therefore be controlled so as to mark product 130 in any one of the plurality of marking positions (or providing cutting or welding of a surface in other embodiments). It will be appreciated that other optical paths 160a to 160e may also comprise additional components that modify the optical path within or between components.

In use, a controller converts marking instructions to control signals for the laser source 110 and marking head 120 to provide laser marking on a surface of the product.

In fiber lasers, laser light can be guided effectively within a fiber core, which can be as small as 9 micrometers in diameter. Combining fiber-based components is relatively straightforward such that laser light can be directed between fiber-based components of a laser marking system relatively easily. In contrast, once laser light exits fiber and becomes a free space laser it is hard to focus it again in a precise and stable way, for example to couple it back into a 9 micrometer fiber core. Optical isolators are typically made from three distinct components that require light to be transmitted through free space. Typical fiber laser marking systems are therefore configured such that an optical isolator is provided at the marking head so that light is transmitted through fiber-based components until exiting fiber-based components into free space in the marking head at the optical isolator where it is subsequently controlled through the marking head, also in free space. The inventors have realised, however, that providing an optical isolator separate from the marking head allows substantial improvements to be made to the dimensions of a marking head given typical size requirements of optical isolators.

FIG. 2 schematically depicts a magnified cross-sectional view of the marking head 120 of FIG. 1. The marking head 120 comprises a receiving portion 210 for receiving a laser beam into the marking head from the umbilical 140 a steering mechanism 220 configured to modify the optical path of the laser beam passing through the marking head and an optical element 230 through which the laser beam exits the marking head towards the product 130. The steering mechanism 220 allows the laser beam to be directed towards the product so as to intersect the product in one of a plurality of marking positions and to mark the product in one of the plurality of marking positions.

The receiving portion 210 may comprise a fiber collimator configured to receive the laser beam from the umbilical and to condition the radiation in a desired manner before directing the radiation to other components of the marking head such as the steering mechanism 220 (which may steer the radiation exiting the marking head in a desired manner).

In some embodiments the steering mechanism 220 is configured to have a compact form factor. For example, the steering mechanism 220 may comprise first and second actuators configured to rotate respective optical elements. The first and second actuators may be, for example, first and second galvanometers. The axis of rotation of the first and second drive mechanisms may be parallel. The axes of rotation may also be parallel to the incoming laser beam. A steering mechanism that allows a compact form factor is described in International Patent Publication Number WO2019/101886, which is incorporated herein by reference in its entirety.

The marking head 120 may be substantially cylindrical. The marking head 120 may have a first dimension in a first direction of less than around 400 mm and a second dimension in a second direction perpendicular to the first direction of less than around 60 mm. The marking head 120 may have a third dimension in a third direction perpendicular to the first direction and the second direction of less than around 60 mm. Providing the isolator separate from a marking head allows a compact form factor that has not previously been possible to achieve.

The marking head 120 may further comprise various other components. For example, the marking head 120 may comprise a focus modifier 240 configured to adjust a focal plane of the laser marking system 100. The marking head 120 may further comprise an outlet 250 for emitting compressed air from the marking head to form an air knife. The marking head 120 may further comprise focusing optics (not shown). The laser marking system may further comprise a detector configured to detect a presence of the product 130. The detector may, for example, comprise a camera. The marking head may additionally include a radiation shield (not shown).

The marking head 120 may comprise a cooling system for providing cooling to a component (e.g. actuators of the steering mechanism 220 and/or the focus modifier 240). The cooling system may be configured to use fluid provided to the marking head to cool a component of the marking head 120. The fluid may be provided so as to cool at least one component of the marking head 120 whilst isolating the fluid from the optical path of the laser, for example by providing a fluid flow path through a housing of the marking head 120 that intersects the component to be cooled. The component may intersect the fluid flow path through the housing to provide a part of the fluid flow path. The fluid may be emitted from the marking head 120 from outlet 250. The outlet 250 may be configured so as to emit fluid from the marking head to reduce matter generated by interaction of the laser beam with a surface of the product from interacting with the print head, for example by way of an air knife. That is, the same fluid used for cooling components within the marking head may also be used as an air knife. It will be appreciated that by providing a compact form for a marking head as allowed by the subject matter described herein, cooling of components within the marking head 120 may be beneficial.

Referring now to FIG. 3, the cabinet 160 of FIG. 1 is shown in further detail. As described above, the cabinet 160 houses laser source 110 and optical isolator 150. The cabinet may additionally house a cooling system 310 configured to generate a flow of fluid for cooling components within the marking head 120. The cooling system may, for example, comprise an air compressor and the fluid may be compressed air, although it will be appreciated that fluids other than air can be used. As described below with reference to FIG. 4, the fluid may be provided to the marking head through the umbilical, or may be delivered to the marking head by a fluid path that is separate to the umbilical. For example, the fluid may be provided at a flow rate of about 20 liters per minute. The fluid may additionally be used to reduce matter generated by interaction of the laser beam with a surface of the product from interacting with the print head, for example by way of an air knife as described above with reference to FIG. 2.

The cooling system 310 may additionally be configured to provide cooling to the laser source 110. For example, the cooling system 310 may be configured to direct the flow of fluid to the laser source 110 and thereby provide cooling to the laser source 110. The fluid may be provided to the laser source 110 after filtration. The fluid may be provided to the laser source 110 before the fluid is used to cool the marking head 120. Fluid provided to the laser source may be provided at a greater flow rate than provided to the marking head in order to provide effective cooling. The flow rate required to cool the laser source 110 may at least partially depend upon a distribution of heat load on the laser source 110, a duty cycle of the laser source 110, etc. In some embodiments the cooling system 310 may use part of the fluid used to cool the laser source to also cool components in the marking head.

The cooling system 310 may comprise a fan 320 configured to generate the flow of extraction fluid. The cooling system 310 may comprise a filter 330 configured to filter the fluid. The filter 300 may be replaceable after having collected a given amount of matter. The filter 300 may comprise a plurality of filters configured to filter fluid dependent upon its use. For example, fluid for cooling may be filtered by a first filter. In some embodiments fluid used for extraction of material from the marking head may be returned to the cabinet and reused for cooling. Where such recirculation of air is used additional and/or specialty filters may be required to extract material from the air before it is reused for cooling. In some embodiments there may be three filters applied, a first filter for filtering cooling air for the marking head, a second filter for filtering cooling air for the system (laser source, power supply, electronics) a further specialty filter to filter air used for extraction of material from the marking head.

The cabinet 160 may comprise a cooling device 340 configured to cool the fluid before the fluid is directed to the laser source. The cooling device 340 may, for example, comprise a compressor or a heat exchanger.

The cabinet 160 may further comprise a power supply 350 configured to provide power to the laser source 110. The cooling system 310 may be configured to provide cooling to the power supply 350. The cabinet 160 may further comprise a controller 360 for controlling the laser source 110, the cooling system 310 and/or marking head 120. The cooling system 310 may be configured to provide cooling to the controller 270.

FIG. 4 schematically depicts a cross-sectional view of umbilical assembly 140 of FIG. 1. The umbilical assembly 140 comprises an umbilical housing 410 that houses one or more conduits for transmitting one or more components from the cabinet 160 to the marking head 120. The one or more conduits comprise an optical fiber 420 for transmitting a laser beam. The one or more conduits may further comprise an electrically conductive cable 430. The one or more conduits may further comprise ducting 440 for transmitting a fluid, such as the fluid for cooling one or more components of the marking head described above.

The umbilical housing 410 may comprise an integral tube formed from a single extruded pipe. That is, the umbilical housing 410 may have an opening at either end only, but may otherwise have no further openings. An internal diameter of the umbilical housing is large enough to accommodate the collimator 210 of the marking head of the laser marking system shown in FIG. 2. The collimator, isolator and optical fiber 420 may comprise an optical assembly. The optical assembly may be manufactured such that separation of the collimator and/or isolator from the optical fiber 420 after manufacture of the optical assembly may not be possible after manufacture. During manufacture of the laser marking system, the optical assembly may be provided integrally formed. The collimator may be passed through the umbilical housing and configured within the marking head 120 and the isolator may be configured within the cabinet 160. By positioning the isolator in the cabinet, the internal diameter of the umbilical housing may be relatively small as the relatively small collimator can be passed through the umbilical housing whilst maintaining connection between the collimator and the isolator.

The umbilical assembly 140 may be reversibly connectable to the marking head 120 of the laser marking system 100 of FIG. 1. The umbilical assembly may be reversibly connectable to the cabinet 160 of the laser marking system 100 of FIG. 1. The umbilical assembly 140 may be reversibly sealable to the marking head 120 and the cabinet 160 of the laser marking system 100 of FIG. 1 so as to prevent ingress of fluid or debris. An outer surface of the umbilical housing 410 may comprise a chemically resistant material and/or a heat resistant material and/or a material that is impervious to water and/or a hygienic material. The outer surface of the umbilical housing 410 may be smooth.

The electrically conductive cable 430 may be configured to transmit a control signal, e.g. from the controller 360 (shown in FIG. 3) to the steering mechanism 220 (shown in FIG. 2). The electrically conductive cable 430 may be configured to transmit one or more sensor signals, e.g. from components such as the galvanometers and/or sensors located within the marking head to the controller 360 and/or to a user interface of the laser marking system 100. For example, signals may be transmitted from the galvanometers to the controller that indicate a position of the galvanometers to provide position feedback to the controller. The electrically conductive cable 430 may be configured to transmit power and signals to other components within the marking head, e.g. from the power supply 350 (shown in FIG. 1) to the focus modifier 240 (shown in FIG. 2).

The laser marking system 100 may further comprise a user interface, e.g. a graphical user interface. The user interface may form part of the controller 360. The user interface may, for example, comprise a screen for providing visual signals to a user and/or a speaker for providing audio signals to a user. The laser marking system 100 may comprise a transceiver for remote control of the laser marking system 100. The laser marking system 100 may comprise a connection (e.g. an Internet connection of an Ethernet connection) for integration with other devices (e.g. on a production line of which the laser marking system forms a part) via the Internet of Things.

The laser marking process may include providing radiation to the umbilical assembly 140 by coupling a radiation source such as, for example, a fiber laser to the umbilical assembly 140. The coupling of the radiation source to the umbilical assembly is interposed by the optical isolator 150. The umbilical assembly 140 may be connected to the marking head 120. An optical fibre of the umbilical assembly 140 may direct the radiation to a collimator of the marking head 120.

Separation of the isolator from the collimator allows the isolator to be located outside of the marking head 120, thereby enabling a small, lightweight marking head 120 to be used instead of bulky and heavy known marking heads. The steering mechanism 220 may further provide a compact way of controlling the radiation exiting the marking head 120 that allows a further compact form factor for the marking head 120.

The radiation may exit the marking head 120 and be incident upon a product 130. The radiation may mark, etch or otherwise interact with a desired portion of a surface of the product 130 in order to change an appearance of the product 130.

The umbilical assembly 140 further advantageously transmits control signals, power, sensor signals, etc. between components of the cabinet 160 (e.g. the laser source 110 and/or the controller 360) and the marking head 120 whilst being flexible enough to easily reposition the marking head 120 with respect to a production line. The provision of the isolator separate from the print head allows the collimator to be passed through an integral umbilical housing. Providing an integral umbilical housing may allow an umbilical assembly to be provided that meets International Protection Marking standards (“IP”, sometimes known as Ingress Protection Marking) that have not previously been achieved by laser marking systems. For example, a laser marking system may be provided in which the umbilical and marking head meeting IP65 to IP69 standards. This may be advantageous in various environments in which laser marking is desirable to be provided.

In some instances, for example, a laser marking head may be retrofit into a system that previously utilized a continuous inkjet marking head of similar dimensions. Retrofitting a system to include a laser marking head instead of a continuous inkjet marking head may reduce the cost of ownership of the system by reducing the need to purchase additional components such as components for positioning the marking head on a production line.

A laser marking head as disclosed herein may weigh about 0.5 kg, about one tenth the weight of many existing systems. The form factor, size, and weight of aspects and embodiments of the laser scanner/marker system disclosed herein provide for the disclosed laser scanner/marker system to be more easily manipulated. For example, the marking head of the laser scanner/marker system including the housing may be mounted on a movable assembly. The moveable assembly may, for example, be a robot arm that may be moved to follow the contours of a three dimensional object such as a bottle while retaining the same focal distance, for example, about 5 mm from the surface of the object. The ability to move the marking head of the laser scanner/marker system relative to objects being marked may eliminate the need for a stage of a system through which the objects pass to be moveable, thus reducing the mechanical complexity of the system as compared to some existing systems. The ability to move the laser marking head may provide various advantages. For example, the laser marking head may allow three-dimensional laser marking to be provided without requiring manipulation of the target to be marked. In other embodiments the head may provide for use of a laser beam for laser cleaning of complex and/or large targets, such as turbine blades, where moving of the where manipulation of the target may be difficult.

In some embodiments the moveable assembly may form part of a computer numerical control (CNC) machine. The marking head may be provided as one of a plurality of tools that may be selected by the CNC machine to integrate laser marking within the CNC machine. As described above, the head is not, however, limited to marking and a tool providing other laser functionality may also be provided such as laser cutting, laser drilling, deep engraving, or laser-based surface treatments such as hardening of steel. It will be appreciated that CNC machines provide highly accurate operations. By providing a compact laser head as described above that can be used in a CNC machine, the CNC machine can provide functionality that has previously required removal of a machined piece and subsequent configuration of the machined piece within a further system to provide laser-based operations. Precise laser-based operations may therefore be provided in a single machine without requiring repeat configuration of a machined piece.

The following description is intended to supplement that provided above, and so the description of the features and configurations described above still apply. Parts of the above description may be referred to again and/or reiterated below, and may be done so in a more cursory manner to aid explanation of further specific details of the cooling system for the marking head. The following is described with regard to a laser marking system, but any other suitable type of radiation may be used instead of a laser.

Referring to the figures, the laser marking system comprises a laser source for providing a laser beam and a marking head 120 for projecting the laser beam on to a product. The laser source is housed within the cabinet 160 as described above. The cabinet 160 houses the cooling system 310 configured to generate a flow of fluid for cooling components within the marking head 120. The cooling system 310 may, for example, comprise an air compressor and the cooling fluid may be compressed air, although it will be appreciated that fluids other than air or compressed air can be used.

The cooling fluid is provided to the marking head 120 through the umbilical 140 (although in some embodiments, it may be delivered to the marking head by a fluid path that is separate to the umbilical). In particular, the cooling fluid flows from the cabinet 160, through the umbilical 140, and into an air inlet of the marking head. The cabinet 160 may comprise a pump that forces the cooling fluid to flow from the cabinet 160, through the umbilical 140, into an air inlet of the marking head and through the marking head as described herein.

The marking head 120 may be elongate and may define a longitudinal axis LA that passes through the centre of the marking head 120. The marking head 120 may further define a transverse axis crossing a transverse plane TP, which is transverse to the longitudinal axis and passes through the centre of the marking head. The marking head may be substantially cylindrical.

The marking head 120 comprises a housing 1000 for accommodating components required to safely and effectively direct and project the laser beam on to a product. Such components include a component for providing an optical path for the laser beam within the marking head or housing, and a component for controlling the optical path of the laser beam through the marking head or housing (e.g. motors or actuators of the steering mechanism 220 (e.g. galvanometers)). As has been described herein, the marking head may comprise a parallel configuration of the two motors or actuators 2002, 2004 (e.g. galvanometers). It will be appreciated that such motors or actuators may operate at very high frequencies generating significant amounts of heat. It is therefore important that this heat is effectively dissipated to prevent overheating. The marking head 120 may additionally comprise a sleeve 121 for receiving the housing 1000.

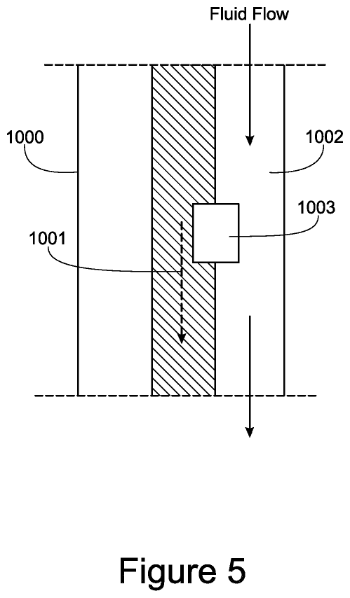

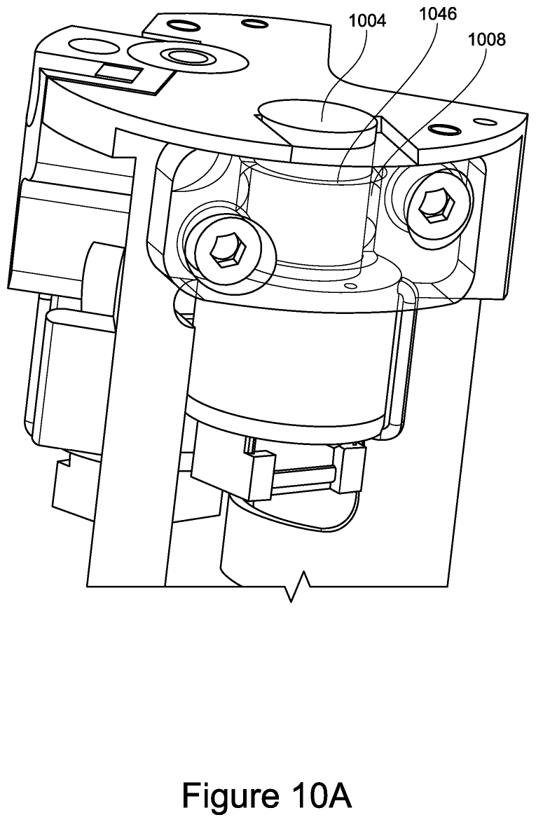

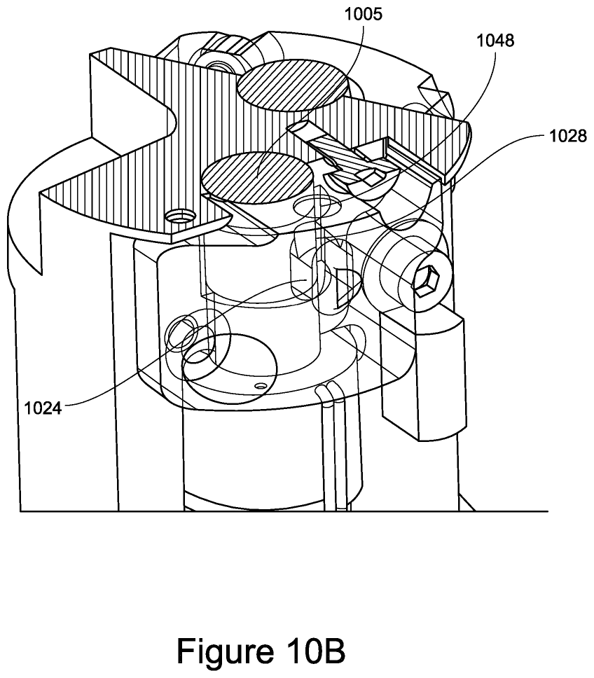

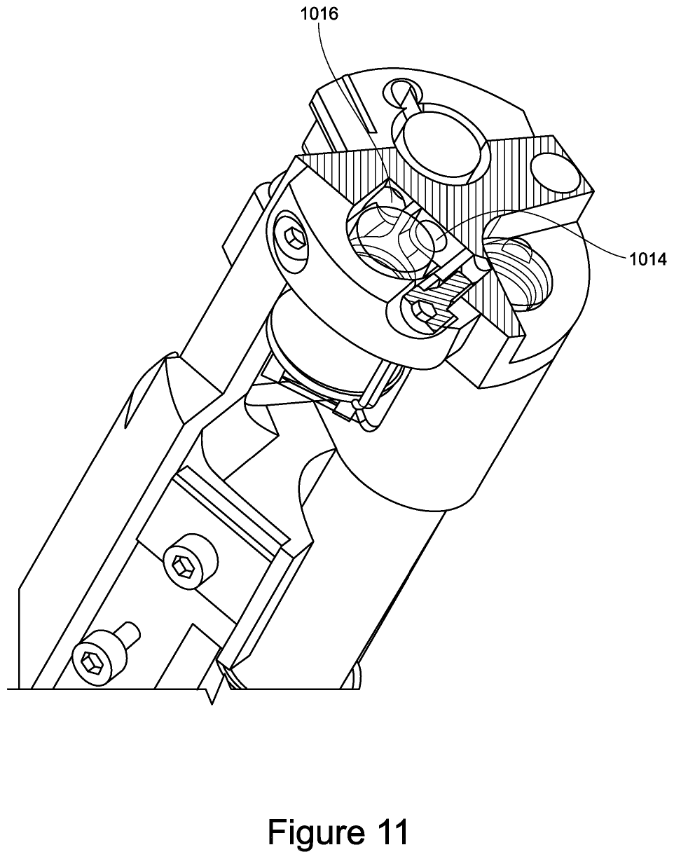

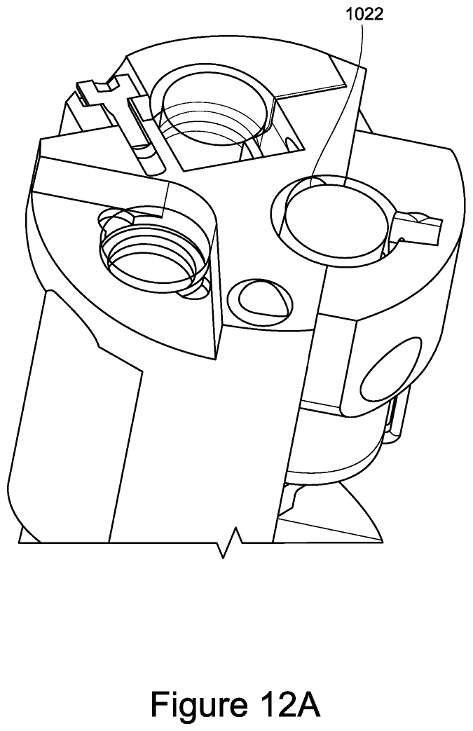

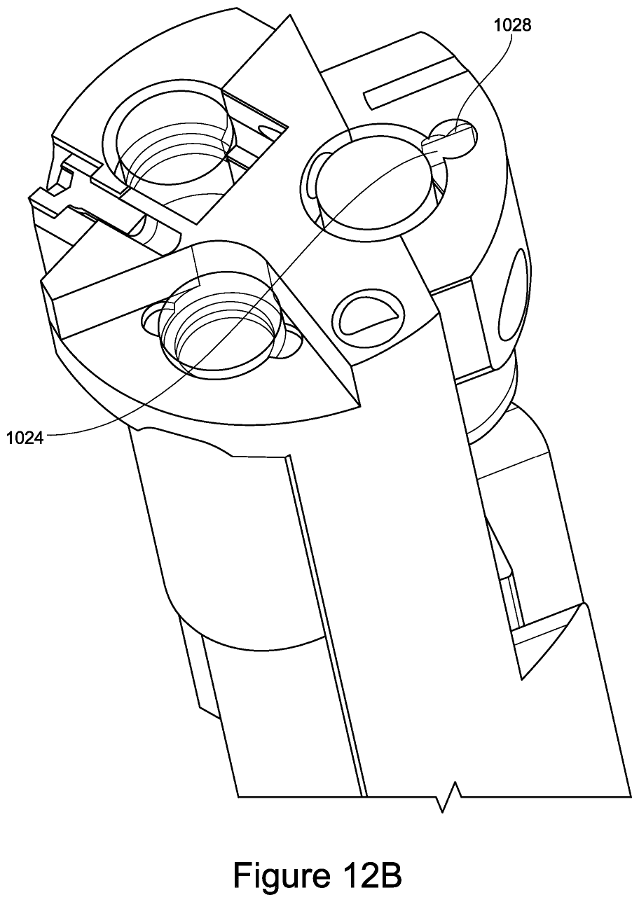

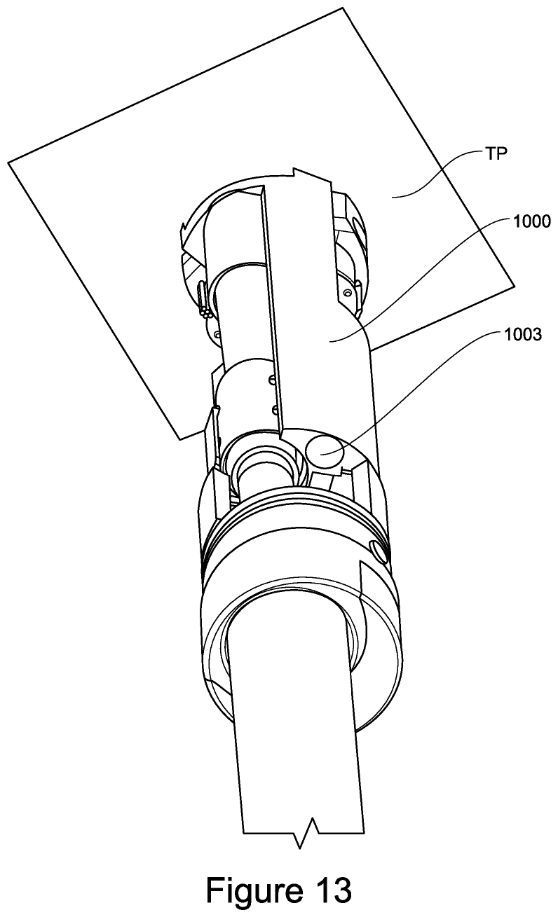

The cooling system within the marking head will now be described with reference to FIGS. 5 to 20, and in particular FIGS. 5 to 13. In the figures, unless otherwise indicated, arrows are generally intended to indicate the intended flow of the cooling fluid through the housing 1000.

Referring to FIG. 5, the housing 1000 of the marking head defines an optical path 1001 for a radiation beam passing through the marking head, and a fluid path 1002 for cooling a component 1003 of the marking head. As indicated in the figure, the optical path 1001 is isolated from the fluid path 1002 within the marking head.

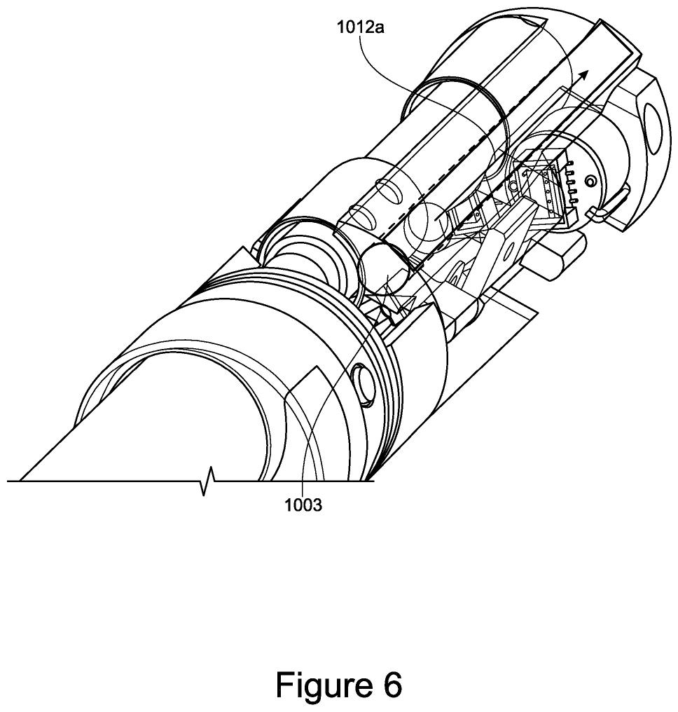

Referring to FIG. 6, the housing 1000 defines an inlet 1003 for receiving the cooling fluid from the cabinet 160. This inlet 1003 may provide a fluid inlet for the cooling system of the marking head 120. The housing 1000 also defines an outlet for emitting the cooling fluid from the marking head 120. The housing 1000 defines a fluid path for the cooling fluid to flow from the inlet 1003, through the housing 1000 to cool a component of the marking head 120, and to the outlet. The fluid path isolates the cooling fluid from the optical path of the laser beam within the marking head 120 and/or the housing 1000, for example by providing a fluid flow path through the housing of the marking head 120 that intersects and only contacts an outer surface of the component to be cooled.

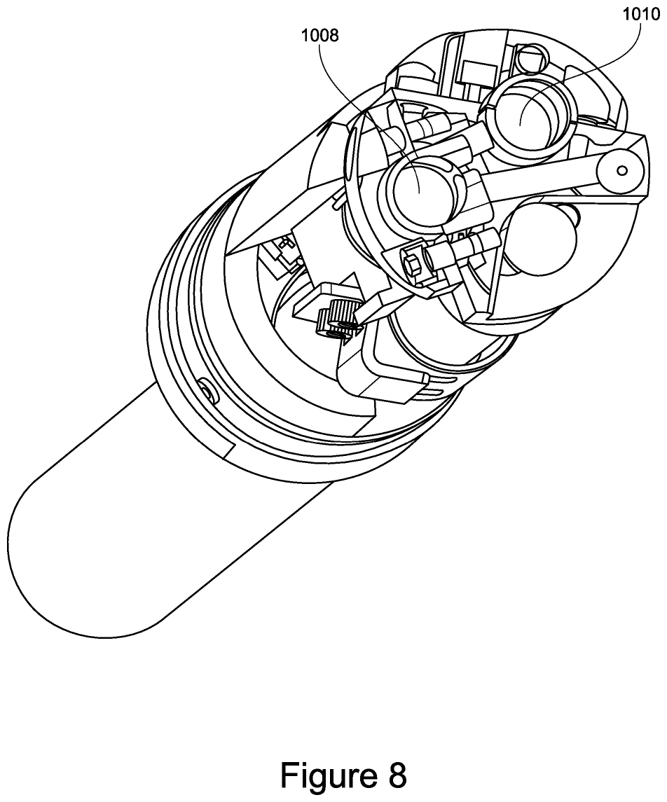

With reference to FIG. 8, the housing 1000 defines a first cavity 1008 for enclosing at least one first component 1004 for controlling the optical path of the laser beam within the marking head 120, for example a first actuator 1004. The first cavity 1008 may be substantially cylindrical and/or the first actuator 1004 may be substantially cylindrical.

In some embodiments, the housing 1000 defines a second cavity 1010 for enclosing at least one second component 1005 for controlling the optical path of the laser beam within the marking head 120, for example a second actuator 1005. The second cavity 1010 may be substantially cylindrical and/or the second actuator 1005 may be substantially cylindrical. For a parallel configuration of the two actuators, the first and second cavities are substantially parallel, although other configurations are of course possible.

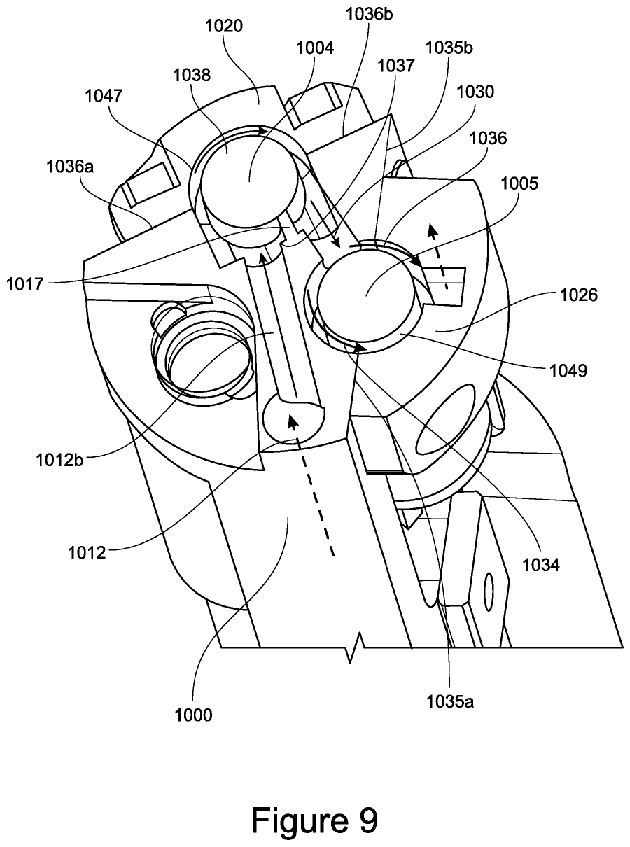

With reference to at least FIGS. 6 and 9, the housing 1000 defines at least a first fluid channel 1012 or conduit for fluid to flow from the inlet 1003 to the first cavity 1008. A first portion 1012a of the first fluid conduit may be substantially parallel to the longitudinal axis LA of the marking head and/or to the longitudinal axis of the actuators 1004, 1005, but may be positioned off-centre within the marking head 120. The first actuator 1004 may comprise a first section, which may be the portion of the first actuator where most of its heat is generated. The first cavity may be configured to enclose this first section of the first actuator 1004 to cool it.

When the first fluid conduit 1012 reaches a point within the marking head that is substantially aligned with the first cavity 1008, the first fluid conduit 1012 may bend through substantially 90° providing a second portion 1012b of the first fluid conduit that is substantially transverse to the longitudinal axis of the marking head 120 (see FIGS. 6 and 9). The first fluid conduit 1012 may bend at another point within the marking head 120, and/or it may bend through an angle other than substantially 90°. Either way, the second portion 1012b of the first fluid conduit travels towards the first cavity 1008 to provide a fluid path to the first cavity 1008.

The first cavity 1008 defines a surface, and the surface defines two openings 1014, 1016 therein. The two openings 1014, 1016 are arranged so fluid flows through them in a substantially transverse direction. The second part 1012b of the first channel cooperates with the first opening 1014 so that cooling fluid from the inlet 1003 can flow through the first channel 1012 and through the first opening 1014.

As can be seen in FIG. 9, in some embodiments, the housing 1000 may define a wall portion, or barrier, 1017 that protrudes into the first cavity 1008.

In some embodiments, the first actuator 1004 may be supported within the housing 1000 and/or marking head 120 by a first support member 1020, for example a first bracket 1020. The first support member 1020 may be configured to receive the first actuator 1004, and the first support member 1020 may be configured to be received by the housing 1000 adjacent the first cavity 1008. The first support member 1020 may extend around an outer side (outer relative to the housing 1000) of the first cavity 1008 for supporting the first actuator 1004 within the first cavity 1008.

The first support member 1020 may define a first recess 1046 therein, extending from an inner surface of the first support member 1020, which is the surface that contacts the first actuator 1004 when the first actuator 1004 is received by the first support member 1020. The first recess 1046 defines one of more edges that provide contact between the first support member 1020 and an outer surface of the first actuator 1004 when the first actuator 1004 is received by the first support member 1020. When the first support member 1020 cooperates with the housing 1000 and the first actuator 1004 is enclosed within the first cavity 1008, the first recess cooperates with the first cavity 1008 and the two openings 1014, 1016 to define a channel 1047 extending from the first opening 1014, over an outer surface of the first actuator 1004 and to the second opening 1016. The one or more edges of the first recess 1046 ensure any fluid in the channel 1047 is retained within the channel 1047. In this case, the channel 1047 is formed by the housing 1000, the first support member 1020 and the first actuator 1004, when the first actuator 1004 is received within the first cavity 1008 and the first support member 1020.

The position of the wall portion 1017 forces fluid to flow through the channel 1046 in one direction, in a longer direction, past the outer side (relative to the housing 1000) of the first actuator 1004. Given that this is a longer fluid path than would be provided by the section blocked by the wall portion 1017, this provides for improved cooling. As such, fluid flows out of the channel 1047 and first cavity 1008 through the second opening 1016.

The second cavity 1010 defines a surface, and the surface defines a third opening 1022. The third 1022 opening is arranged in a side surface so that fluid flows through it in a substantially transverse direction.

In some embodiments, the second actuator 1005 may be supported within the housing 1000 and/or marking head 120 by a second support member 1026, for example a second bracket 1026. The second support member 1026 may be configured to receive the second actuator 1005, and the second support member 1026 may be configured to be received by the housing 1000 adjacent the second cavity 1010. The second support member 1026 may extend around an outer side (outer relative to the housing 1000) of the second cavity 1010 for supporting the second actuator 1005 within the second cavity 1010.

The second support member 1026 may define a second recess 1048 therein, extending from an inner surface of the second support member 1026, which is the surface that contacts the second actuator 1005 when the second actuator 1005 is received by the second support member 1026. The second recess 1048 defines one of more edges that provide contact between the second support member 1026 and an outer surface of the second actuator 1005 when the second actuator 1005 is received by the second support member 1026.

The second support member may define a fourth opening 1024 in an inner side surface that cooperates with the second recess 1048. The second support member 1026 may define a fifth opening 1028 in a top side of the second support member 1026, and the second support member 1026 may further define a fluid channel from the fourth opening 1024 to the fifth opening 1028. The fifth opening 1028 is therefore arranged such that fluid is intended to flow through it in a substantially longitudinal direction.

When the second support member 1026 cooperates with the housing 1000 and the second actuator 1005 is enclosed within the second cavity 1010, the second recess 1048 cooperates with the second cavity 1010 and the two openings 1022, 1024 to define a channel 1049 extending from the third opening 1022, around an outer surface of the second actuator 1005 and to the fourth opening 1024. The one or more edges of the second recess 1048 ensure any fluid in the channel 1049 is retained within the channel 1049. In this case, the channel 1049 is formed by the housing 1000, the second support member 1026 and the second actuator 1005, when the second actuator 1005 is received within the second cavity 1010 and the second support member 1026.

As can be seen in FIG. 9 for example, the channel 1049 formed extends around the entire outer surface of the second actuator 1005 without any blocking portion. Therefore, when fluid enters the channel 1049 through the third opening 1022, fluid can flow both ways around the channel to the fourth opening 1024. For example, the fluid can flow along the longer path 1034 around the outer surface of the second actuator 1005 or the shorter path 1036 around the outer surface of the second actuator 1005 (see FIG. 9). As such, the second actuator 1005 is cooled.

The housing 1000 may define a further channel 1030, which may be substantially transverse, that cooperates with the second opening 1016 and the third opening 1022 to provide a flow path from the second opening 1016 to the third opening 1022 and so through the housing 1000 from the first cavity 1008 to the second cavity 1010.

The housing may further define at least one second fluid channel or conduit defining a fluid path for fluid to flow from the fifth opening 1028 and to the outlet. The outlet and part of the housing near the outlet will be described in more detail below.

Following from the above, the path of the cooling fluid into and through the housing is now described when the first actuator 1004 is enclosed within the first cavity 1008 and the second actuator 1005 is enclosed within the second cavity 1010.

Cooling fluid is pumped from the cabinet 160, through the umbilical 140 and into the inlet 1003 of the housing 1000. The cooling fluid flows through the first 1012a and second parts 1012b of the first channel 1012 and through the first opening 1014 into the first channel 1047. The cooling fluid is therefore forced to flow over an outer surface of the first actuator 1004, around the outer side 1038 of the first actuator 1004, to cool to the first actuator 1004. The cooling fluid flows towards the second opening 1016.

The cooling fluid flows out of the second opening 1016 into the further channel 1030 connecting the first 1008 and second 1010 cavities. This dissipates heat away from the first actuator 1004.

The cooling fluid flows through the third opening 1022 and into the channel 1049 formed in the second cavity 1010 extending around the entire outer surface of the second actuator 1005. The cooling fluid flows both ways in the channel around the outer surface of the second actuator 1005 to cool to the second actuator 1005. For example, the fluid flows takes both the longer path 1034 and the shorter path 1036 towards the fourth opening 1024. The cooling fluid flows from the fourth opening 1024, to the fifth opening 28, and from the fifth opening 1028 towards the outlet to dissipate the heat from the second actuator 1005.

Whilst a particular configuration has been described above, it will be appreciated that various modifications can be made to the configuration to provide an effective cooling system for the marking head 120, although not all of these other embodiments are shown. Some of these embodiments are briefly described below.

In some embodiments, the first support member 1020 may not comprise the first recess 1046 or the first recess 1046 may only extend a part of the way around the inside surface of the first support member 1020. In this case, fluid may flow from the first opening 1014 to the second opening 1016 through a channel in the first cavity 1008 defined by only the first actuator 1004 and the housing 1000. The first support member 1020 may provide a barrier to prevent fluid flowing out of the first cavity 1008 when the first actuator 1004 is received within the first cavity 1008.

In some embodiments, the housing 1000 defines the fourth opening 1024 and fifth opening 1028, instead of the second support member 1026, and the position of the channels or conduits leading from the fifth opening 1028 to the outlet are adjusted accordingly. In some embodiments, the second support member 1026 may not comprise the second recess 1048 or the second recess 1048 may only extend a part of the way around the inside surface of the second support member. In this case, fluid may flow from the third opening 1022 to the fourth opening 1024 through a channel in the second cavity 1010 defined by only the second actuator 1005 and the housing 1000. The second support member 1026 may provide a barrier to prevent fluid flowing out of the second cavity 1010 when the second actuator 1005 is received within the second cavity 1010.

In some embodiments, the housing 1000 may not comprise the wall portion, or barrier, 1017. Therefore, fluid flows around the first channel 1046 between the first opening 1014 and the second opening 1016 in both directions, around the inner and outer 1038 sides of the first actuator 1004 when the first actuator 1004 is received within the first cavity 1008. This may allow cooling fluid to flow over the entire outer surface of the first actuator 1004, which may provide enhanced cooling.

In some embodiments, the second cavity 1010 may comprise a wall portion (not shown) or barrier that extends into the second cavity 1010 to ensure that fluid can only flow through the cavity 1048 in one direction between the third opening 1022 and fourth opening 1024. The wall portion may be formed in the second cavity in a similar way to that which wall portion 1017 extends into the first cavity 1008 as described above. It may be the housing 1000 or the second support member 1026 that comprises the wall portion or barrier. This may provide for a more efficient flow through the second channel 1048, which may provide enhanced cooling.

In some embodiments, a single actuator may be provided or, for example, cooling may only be provided to one of a pair of actuators. For example, when cooling is provided to the first actuator 1004, the further channel 1030 is not directed towards the second actuator 1005. The further channel is instead directed towards the outlet to define a fluid path to the outlet. It will be appreciated that whilst it is generally described above that cooling is provided to actuators, in other embodiments one or more components other than actuators may be cooled in a corresponding manner to that described above.

In some embodiments, there may be no first support member 1020. Two outer walls 1036a, 1036b of the housing 1000 may extend further into the first cavity 1008 to contact the first actuator 1004 when the first actuator 1004 is received within the first cavity 1008. For example, the housing 1000 may comprise two sealing portions that extend from the outer walls 1036a, 1036b into the first cavity 1008 to contact the first actuator 1004 when the first actuator 1004 is received within the first cavity 1008. In this case, the wall portion 1017 may be partly or fully removed so that a channel exists between the first opening 1014 and the second opening 1016, along an inner wall 1037 of the housing 1000, and around an inner side (relative to the housing) of the first actuator 1004 when the first actuator 1004 is received within the first cavity 1008. In this case, a channel is formed by only the housing 1000 and the first actuator 1004 when the first actuator 1004 is received within the first cavity 1008.

Similarly, in some embodiments, there may be no second support member 1026. Two outer walls 1035a, 1035b of the housing 1000 may extend further into the second cavity 1010 to contact the second actuator 1005 when the second actuator 1005 is received within the second cavity 1010. For example, the housing 1000 may comprise two sealing portions that extend from the outer walls 1035a, 1035b into the second cavity 1010 to contact the second actuator 1005 when the second actuator 1004 is received within the second cavity 1010. In this case, a channel is formed by only the housing 1000 and the second actuator 1005 when the second actuator 1005 is received within the first cavity 1008.

In this case, the housing 1000 defines the fourth opening 1024 and fifth opening 1028, instead of the second support member 1026, and the position of the channels or conduits leading from the fifth opening 1028 to the outlet are adjusted accordingly.

The marking head 120 may comprise an outlet 250 for emitting fluid from the head. The outlet 250 may be arranged to cooperate with an outlet of the housing 1000 through which fluid exits the housing. The outlets of the marking head 120 and housing 1000 may be fluidly connected.

The outlet 250 of the marking head 120 may be provided in an end cap or end cover that is received by an end of the marking head through which the laser beam is emitted from the marking head. The marking head may define a cavity configured to receive the end cap. The end cap may cooperate with the marking head and/or housing to provide fluid and electromagnetic radiative communication there between. The end cap may connect to and/or cooperate with the housing 1000.

The marking head 120 may comprise an optical element for emitting the laser beam out of the marking head 120. The optical element may have an optical power for focusing the laser beam. The optical element may have substantially no optical power. The end cap may define a cavity 1070 configured to receive the optical element 1042. The outlet 250 may be adjacent the optical element, on the same end surface of the marking head 120.

In some embodiments, the marking head 120 may comprise an optical element assembly for emitting the laser beam out of the marking head 120. The assembly may comprise a first optical element which is arranged to receive the radiation beam to be emitted from the marking head. The first optical element may be integrally formed with the head. The assembly may comprise a second optical element which may be arranged to cover the first optical element. The second optical element may be arranged to receive the radiation beam emitted from the first optical element. The second optical element may be detachably connectable to the head. The second optical element may be mounted to the head, for example by using screws. The plane of the first optical element may be substantially parallel to the plane of the second optical element.

The provision of an optical element assembly in this way may be advantageous. The second optical element may protect the first optical element and the first optical element may maintain integrity of the internal components of the marking head 120. Providing an additional optical element that overlays the first optical element, prevents any particulate matter from contacting the first optical element. The second optical element is also detachable and so can be easily replaced, for example if particulate matter scratches or attaches to the surface of the second optical element.

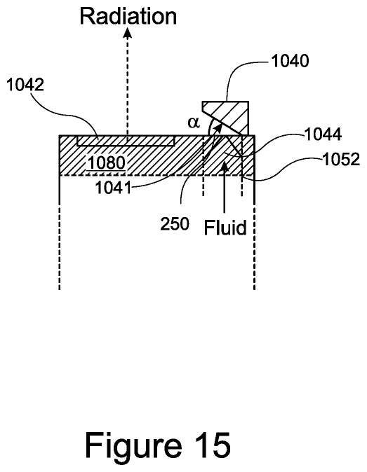

The housing 1000, cooling system and outlets may be arranged to create an air knife at the outlet, which will now be described with reference to the figures, particularly FIGS. 15 to 20. The air knife is generated across the optical element for emitting the laser beam out of the marking head 120 and at a predetermined angle relative to an axis of the optical element. The housing 1000 may comprise one or more fluid channels or conduits, comprising or consisting of the at least one second fluid channel, which take the cooling fluid received at the fifth opening 1028 to the outlet to be emitted from the marking head. The one or more fluid channels or conduits can take any suitable path through the marking head provided the fluid channels or conduits at no point intersect an optical path of the laser beam. That is, the fluid is isolated from a cavity in which the optical path of the laser beam passes and/or is manipulated.

The emission of the cooling fluid at the outlet is used to create an air knife that passes across the optical element through which radiation is emitted from the optical element 1042 of the marking head 120. The inventors have found that by emitting the cooling fluid at the outlet at a predetermined angle relative to a plane defined by the optical element 1042, a more effective air knife is created with reduced turbulence surrounding the air knife i.e. where the surrounding turbulence is minimised. This air knife is more effective for preventing any solid matter deflecting back up on to the marking head and optical element 1042, since reduced turbulence surrounding the air knife means that there is less likely to be any undesirable turbulent flow generated that would direct any solid matter back up onto the optical element 1042. The air knife is also useful for dissipating any unpleasant and/or harmful fumes that may be produced during marking.

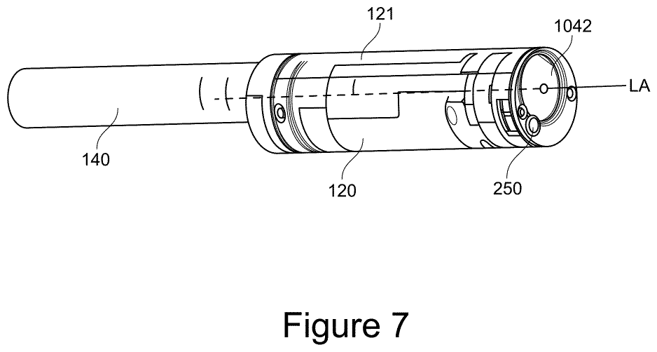

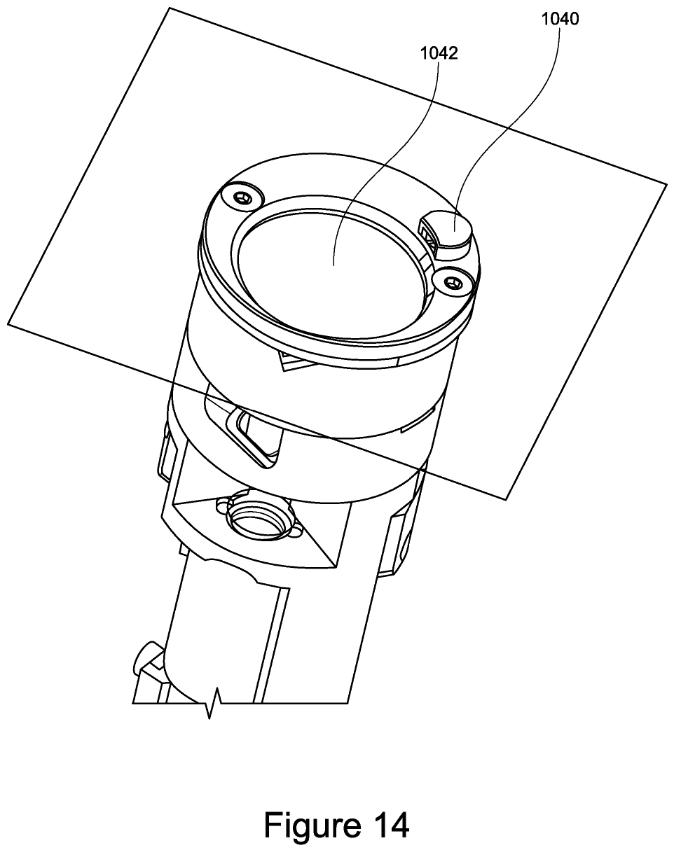

The marking head 120 may have a straight configuration (as shown in at least FIG. 7), where the laser beam is emitted from the marking head parallel to the longitudinal axis LA of the marking head 120. For these embodiments, with reference to FIGS. 14 and 15, the housing 1000 and/or marking head 120 may comprise a cover or hooded cap 1040 that sits over the housing outlet so that the cooling fluid is forced into the hooded cap 1040 on emission from the interior of the marking head 120. The end cap or end cover 1080 for the marking head (see FIG. 15) may comprise the cover 1040. The cover 1040 may be arranged to receive cooling fluid from an outlet of the housing 1000.

The hooded cap 1040 may comprise a guide member, which may be an inner surface 1041 arranged so that cooling fluid emitted from the outlet 250, hits the inner surface 1041 and travels over the inner surface 1041. The inner surface 1041 is configured at a predetermined angle, a, relative to a plane defined by the outlet or optical element 1042. Therefore, as the cooling fluid hits the inner surface 1041, the cooling fluid is forced to flow at this same predetermined angle. The fluid therefore flows across the optical element 1042 at this predetermined angle, forming an air knife at this angle. It has been found that forming the air knife in this way results in a more effective air knife with reduced surrounding turbulence.

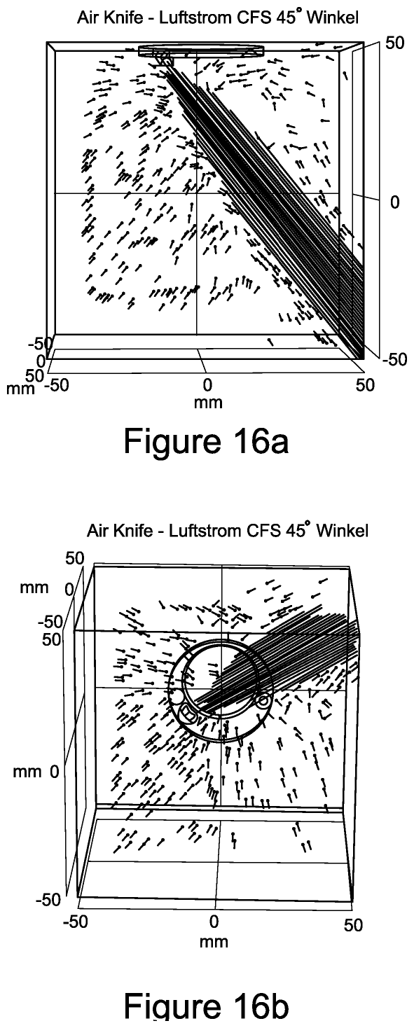

The inventors have found that for a straight configuration of the marking head 120, the predetermined angle, a, should be substantially 45°. Some airflow simulations were undertaken to show the effective air knife being created for the straight configuration with a predetermined angle, a, of 45°, and the results of this are shown in FIGS. 16a and 16b. It can be clearly seen that there is little air turbulence surrounding the air knife.

The housing 1000 may comprise a duct or final channel 1052 at the outlet 250 that fluidly connects the one or more fluid channels or conduits to the outlet 250. The duct 1052 may comprise a valve 1044, for example a duck bill valve, for preventing backflow and/or the ingress of fluid and/or solid or particulate matter into the outlet 250 and housing. The combination of the valve 1044 and hooded cap 1040 has contributed to the housing 1000 meeting the International Protection Marking standards (“IP”, sometimes known as Ingress Protection Marking), in particular the IP69 standard which allows for high pressure steam cleaning of the housing 1000. This may be advantageous in various environments in which laser marking is desirable to be provided.

The cooling system therefore serves a dual purpose of cooling, as well as providing an effective air knife to prevent particulate matter hitting the optical element of the marking head where radiation exits the head—cooling fluid received by the housing 1000 from the cabinet 160 flows through the housing to provide cooling as described herein, and this cooling fluid then travels towards the outlet to provide the above described air knife.

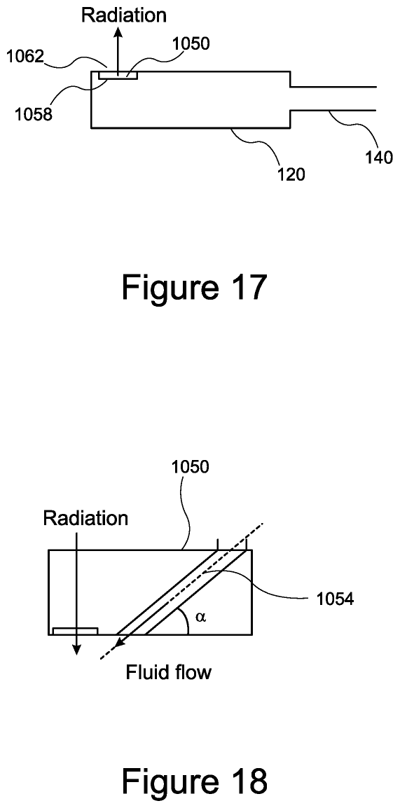

The marking head 120 may have a right-angled or 90° configuration (as shown in FIG. 17) where the laser beam is emitted at substantially 90° to the longitudinal axis of the marking head. For these embodiments, the marking head 120 may comprise a cap or cover 1050 for mounting on a radial surface of the marking head 120 where the laser beam is to be emitted from the head. The radial surface may be substantially flat where the cap is to be mounted and the cap may be substantially cuboidal. An outer surface 1062 of the cap may be configured with an associated radius of curvature that matches a radius of curvature of the marking head at that part. The radius of curvature may be approximately 20 mm, for example where the marking head 120 has a diameter of approximately 40 mm. It will be appreciated from the descriptions provided, that a cap for a marking head with a straight configuration may be configured differently to a cap for a marking head having a right-angled configuration.

The cap 1050 may comprise the optical element 1042 through which the laser beam passes to be emitted from the head, the optical element defining an optical element plane in which the optical element 1042 lies. The optical element plane 1042 may correspond with the transverse plane of the head at its end where radiation exits the head 120. The cap 1050 also defines the outlet through which the cooling fluid is emitted from the marking head.

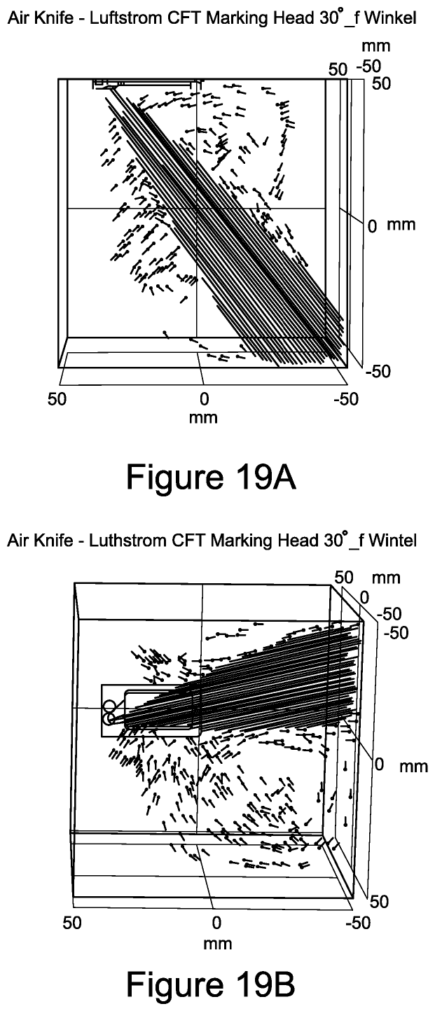

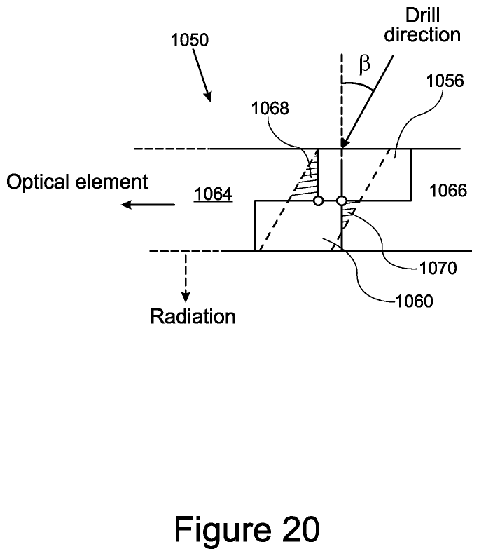

With reference to FIG. 18, the cap 1050 defines a duct or bore or channel 1054 there through that receives cooling fluid from the one or more fluid channels or conduits fluidly connecting to the outlet 250. The duct 1054 may be defined diagonally through the cap 1050. The duct or bore 1054 may have a longitudinal axis as indicated in FIG. 18. The duct is arranged so that its longitudinal axis is angled relative to the optical element plane. In particular, the duct 1054 is configured at a predetermined angle, a, relative to the optical element plane, so that the cooling fluid is forced to flow through the duct 1054 and out of the cap 1050 at this predetermined angle. The inventors have found that for a marking head with a 90° configuration, the longitudinal axis of the duct 1054 should be arranged at substantially 60° to the optical element plane of the marking head, i.e. the predetermined angle, a, should be substantially 60°, to provide an effective air knife with reduced surrounding turbulence. Some airflow simulations were undertaken to show the effective air knife created for the marking head with a 90° configuration and having a duct at a predetermined angle of 60°, and the results of this are shown in FIGS. 19a and 19b. It can be clearly seen that there is little air turbulence surrounding the air knife.

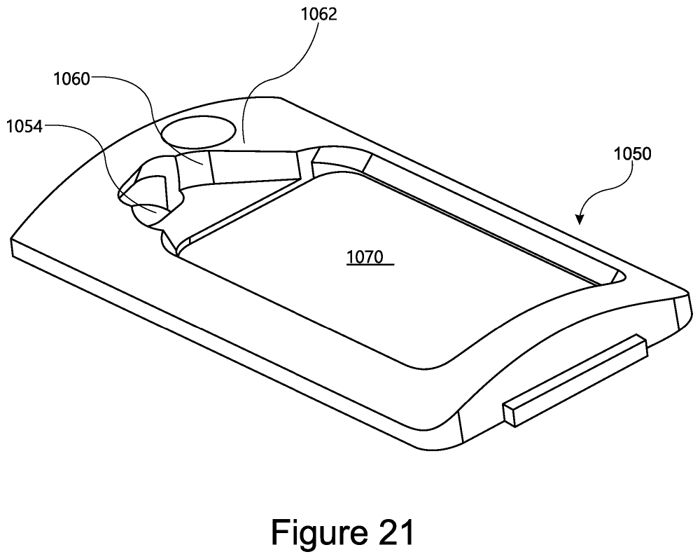

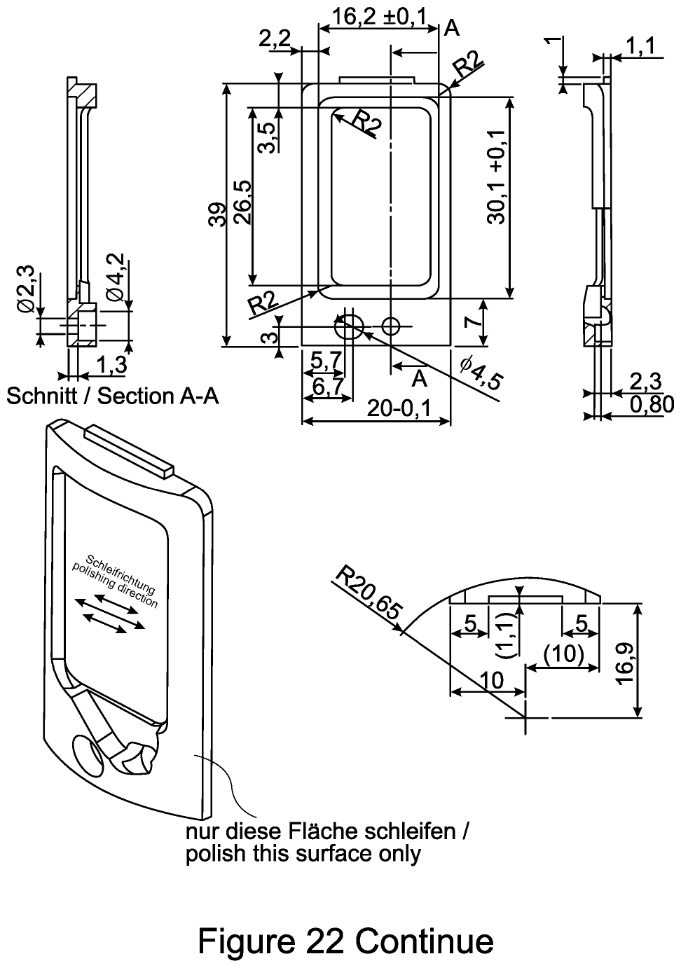

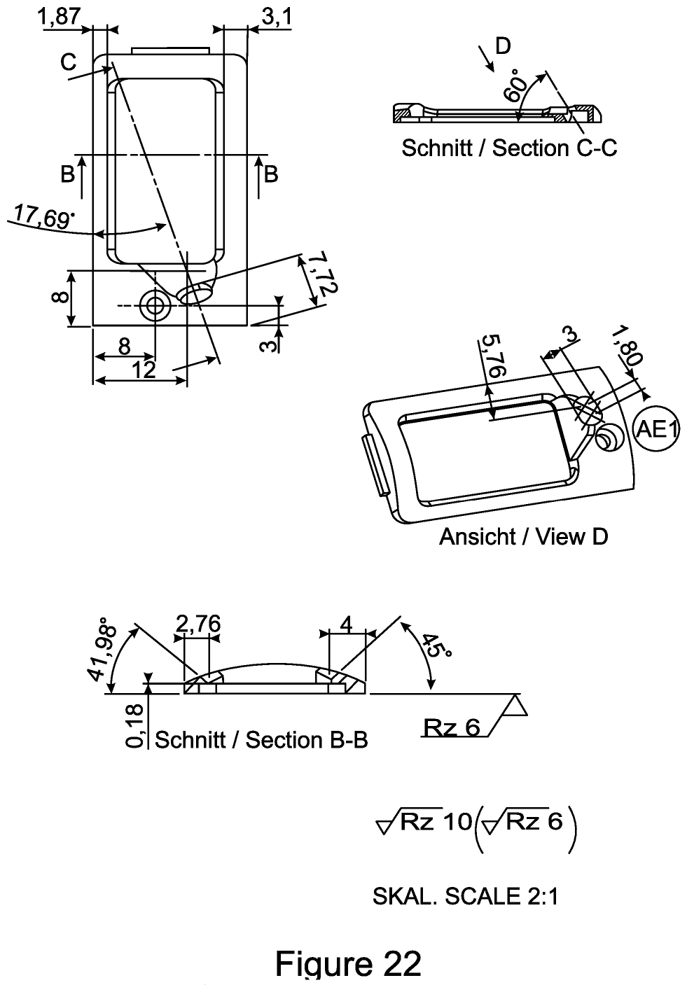

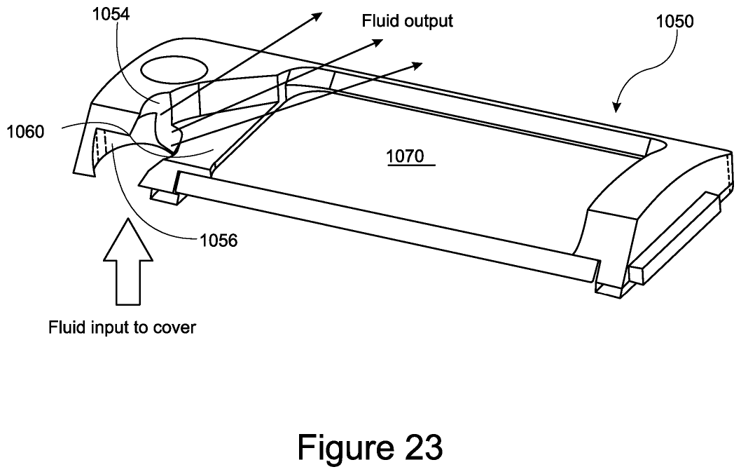

With reference to FIGS. 20-23, the inventors have identified a particularly advantageous method for creating the duct or bore or channel 1054 in or through the cap 1050. With reference to FIG. 20, a first pocket or bore 1056 is defined in a top or inner side 1058 of the cap 1050, for example by a drill. The first pocket may have a diameter of between approximately 2 and 5 mm, for example approximately 4 mm. The top or inner side 1058 is the side that would be inner most to the marking head 120 when the cap 1050 is mounted on the marking head 120 (see FIG. 17). A second pocket or bore 1060 is defined in an under or outer side 1062 of the cap 1050, for example by a drill. The under or outer side 1062 is the side that would be outer most to the marking head 120 when the cap 1050 is mounted on the marking head 120 (see FIG. 17). The second pocket 1060 is defined towards an optical element side of the cap 1050, a side closer to the optical element, and the first pocket is defined on a second side 1066 further from the optical element. From a side view of the cap 1050 bas indicated in FIG. 20, the first 1056 and second 1060 pockets are offset in the transverse direction. It will of course be appreciated that first and second are used for ease of reference to each pocket but the second pocket 1060 could be defined in the cap 1050 before the first pocket 1056. The first pocket may define a fluid input for the cap 1050 for cooperating with a fluid output of the marking head housing 1000, and/or the second pocket may define a fluid output for the cap 1050 (and for the marking head 120).

A drill having a predetermined drill bit size may then be used to define the duct 1054 through the pockets 1056, 1060. The drill bit may have a diameter of between approximately 2 and 5 mm, for example approximately 4 mm. The drilling direction, β, is predetermined. Other suitable means of defining the hole can be used. The duct 1054 can then be defined through the pockets 1056, 1060 on either the optical element side 1064 or the second side 1066 of the cap 1050. Defining the duct 1054 on the optical element side 1064 means more cap material 1068 is removed on the optical element side 1064 of the first pocket 1056 than on the second side 1066 of the second pocket 1060. Defining the duct 1054 on the second side 1066 means more cap material 1070 is removed on the second side 1066 of the second pocket 1060 than on the optical element side 1064 of the first pocket 1056.

The inventors have found that using a drilling direction, β, of substantially 60° to define a duct or bore 1054 at a 60° angle through the cap 1050 as described above, and defining the duct on the optical element side 1064 of the pockets 1056, 1060, provides the most effective air knife with reduced surrounding turbulence.

The laser marking system described and depicted herein may advantageously overcome problems associated with known laser marking systems offering a fully integrated, “plug-and-play” solution for owners of a production line.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The electromagnetic radiation steering mechanism may include various types of optical components, such as refractive, reflective, magnetic, electromagnetic, electrostatic, and/or other types of optical components, or any combination thereof, for directing, shaping, and/or controlling electromagnetic radiation.

Although specific reference may be made in this text to the use of an electromagnetic radiation steering mechanism in the marking of products, it should be understood that the electromagnetic radiation steering mechanism described herein may have other applications. Possible other applications include laser systems for engraving products, optical scanners, radiation detection systems, medical devices, etc.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

1. A housing for a head for directing an electromagnetic radiation beam at a target, the housing comprising:
an inlet configured to receive a fluid into the housing;
a support member defining a cavity for configured to receive at least one component configured to control the optical path of the radiation beam within the head;
an outlet configured to receive the fluid out of the housing;
a first channel defining a first fluid path from the inlet to the cavity; and
a second channel defining a second fluid path from the cavity to the outlet;
wherein when the at least one component is enclosed within the cavity, the housing and the at least one component further define a third channel between the first channel and the second channel; and
wherein the first channel, second channel and third channel are configured to isolate the fluid from the optical path of the radiation beam within the head.

2. The housing as claimed in claim 1, wherein the housing is configured to cooperate with the support member for supporting the at least one component within the cavity, wherein the housing is configured to cooperate with the support member and the at least one component for enclosing the at least one component within the cavity.

3. The housing as claimed in claim 2, wherein the support member comprises a recessed portion for cooperating with the cavity and the at least one component when the support member is supporting the at least one component within the cavity,
wherein at least one of the housing, the at least one component and the support member define at least a part of the third channel, or
the cavity and the recessed portion provide at least a part of the third channel.

4. The housing as claimed in claim 1, wherein the housing comprises a second cavity for enclosing at least one second component for controlling the optical path of the laser beam within the marking head, and wherein the housing defines a fourth channel defining a fluid path from the third channel to the second channel, and wherein the fourth channel is fluidly connected to the second cavity, wherein the first channel, second channel, third channel and fourth channel are configured to isolate the fluid from the optical path of the radiation beam within the head.

5. The housing as claimed in claim 4, wherein when the at least one second component for controlling the optical path of the radiation beam is enclosed within the second cavity, the housing and the at least one second component define a fifth channel between the fourth channel and the second channel wherein the first channel, second channel, third channel, fourth channel and fifth channel are configured to isolate the fluid from the optical path of the radiation beam within the head.

6. The housing as claimed in claim 4, wherein the first cavity defines a first longitudinal axis and the second cavity defines a second longitudinal axis, and wherein the first longitudinal axis is substantially parallel to the second longitudinal axis and to a longitudinal axis of the head.

7. The housing as claimed in claim 1, wherein the outlet is fluidly connected to a guide portion and the guide portion is arranged to receive fluid from the outlet and to direct the fluid at a predetermined angle relative to a plane comprising an optical element of the head though which radiation is emitted from the head and towards the emitted radiation.

8. The housing as claimed in claim 7, wherein the guide portion comprises at least one surface arranged at the predetermined angle, and wherein the at least one surface is arranged to receive fluid from the outlet and to direct the fluid at the predetermined angle.

9. The housing as claimed in claim 7, wherein the head defines a longitudinal axis, and wherein the head is configured to direct a radiation beam out of the head in a direction substantially parallel to the longitudinal axis, and wherein the predetermined angle is substantially 45 degrees.

10. The housing as claimed in claim 7, wherein the head defines a longitudinal axis, and wherein the head is configured to direct a radiation beam out of the head in a direction substantially transverse to the longitudinal axis, and wherein the predetermined angle is substantially 60 degrees.

11. The housing as claimed in claim 1, wherein the at least one component for controlling the optical path of the radiation beam within the head is a first actuator configured to rotate a first optical element of a radiation steering mechanism about a first rotational axis, or, wherein the at least one second component for controlling the optical path of the radiation beam within the head is a second actuator configured to rotate a second optical element about a second rotational axis.

12. The housing as claimed in claim 1, wherein the electromagnetic radiation is laser, and/or wherein the head is a marking head.

13. A head for directing an electromagnetic radiation beam at a target, the head comprising:
the housing according to claim 1;
(a) and (b) the at least one component for controlling the optical path of the radiation beam within the marking head.

14.-18. (canceled)

19. The head as claimed in claim 13, wherein the head comprises an optical element assembly for emitting the radiation beam from the head, wherein the optical element assembly comprises a first optical element arranged to receive the radiation beam to be emitted from the head, and a second optical element arranged to cover the first optical element and to receive the radiation beam emitted from the first optical element for emitting the radiation beam from the head.

20. The head as claimed in claim 13, wherein the head comprises an optical element through which radiation is emitted from the head, and wherein the head comprises a guide portion arranged to receive fluid from the outlet and to direct the fluid at a predetermined angle relative to a plane comprising an optical element of the head through which radiation is emitted from the head and towards the emitted radiation.

21.-26. (canceled)

27. An electromagnetic radiation system for directing an electromagnetic radiation beam at a target comprising:
(a) a cabinet comprising a radiation source for providing an electromagnetic radiation beam, and a fluid source for providing cooling fluid; and
(b) a head connected to the cabinet, the head for directing the radiation beam at a target and for receiving the cooling fluid for cooling at least one component for controlling the optical path of the radiation beam within the head, the head comprising:
(i) a housing for the head accordion to claim 1; and
(ii) the at least one component for controlling the optical path of the radiation beam within the head.

28. A method of manufacturing a head for directing an electromagnetic radiation beam at a target, wherein the head includes a housing comprising:
an inlet configured to receive a fluid into the housing;
a support structure defining a cavity configured to receive at least one component for controlling the optical path of the radiation beam within the head;
an outlet configured to receive the fluid as it exits the housing;
a first channel defining a first fluid path from the inlet to the cavity; and
a second channel defining a second fluid path from the cavity to the outlet; and
the method comprising enclosing the at least one component for controlling the optical path of the radiation beam within the cavity such that the housing and the at least one component further define a third channel between the first channel and the second channel;
wherein the first channel, second channel and third channel are configured to isolate the fluid from the optical path of the radiation beam within the head.

29.-32. (canceled)

33. The method as claimed in claim 27, wherein the head has an optical element assembly for emitting the radiation beam from the head, wherein the optical element assembly comprises a first optical element arranged to receive the radiation beam to be emitted from the head, and a second optical element arranged to cover the first optical element and to receive the radiation beam emitted from the first optical element for emitting the radiation beam from the head.

34. The method as claimed in claim 27, wherein the head has an optical element through which radiation is emitted from the head, and the method comprising arranging a guide portion on the head to receive fluid from the outlet and to direct the fluid at a predetermined angle relative to a plane comprising an optical element of the head through which radiation is emitted head and towards the emitted radiation, or wherein the guide portion comprises at least one surface for directing the fluid at the predetermined angle.

35.-39. (canceled)

40. A method of manufacturing an electromagnetic radiation system for directing an electromagnetic radiation beam at a target, the method comprising:
(a) assembling a marking head for directing an electromagnetic radiation beam at a target, wherein the marking head includes a housing comprising:
an inlet configured to receive a fluid into the housing;
a support member defining a cavity configured to receive at least one component for controlling the optical path of the radiation beam within the head;
an outlet for the fluid through which the fluid passes;
a first channel defining a first fluid path from the inlet to the cavity; and
a second channel defining a second fluid path from the cavity to the outlet; and
the assembling step includes enclosing the at least one component for controlling the optical path of the radiation beam within the cavity such that the housing and the at least one component further define a third channel between the first channel and the second channel; wherein the first channel, second channel and third channel are configured to isolate the fluid from the optical path of the radiation beam within the head; and
(b) connecting the head to a cabinet, the cabinet comprising a radiation source for providing the radiation beam, and a fluid source for providing cooling fluid to the head to cool the at least one component for controlling the optical path of the radiation beam within the head.
